(19) United States
(12) Patent Application Publication
(10) Pub. No.: US 2019/0210456 A1
(43) Pub. Date: Jul. 11, 2019

(54) VALVE ASSEMBLY

(71) Applicant: Eaton Intelligent Power Limited, Dublin (IE)

(72) Inventors: Paul Douglas Walkowski, Ann Arbor, MI (US); Ronald Earl Sexton, South Lyon, MI (US)

(73) Assignee: Eaton Intelligent Power Limited, Dublin (IE)

(21) Appl. No.: 16/311,737

(22) PCT Filed: Jun. 23, 2017
(86) PCT No.: PCT/US2017/038982

§ 371 Date: Dec. 20, 2018

Related U.S. Application Data
(60) Provisional application No. 62/354,388, filed on Jun. 24, 2016.
(60) Provisional application No. 62/521,870, filed on Jun. 19, 2017.

(51) Int. Cl. B60K 15/035; F16K 1/36

(52) U.S. Cl. CPC B60K 15/03519; F16K 1/46; F16K 1/36

(57) ABSTRACT

A valve assembly includes a valve body and a seat defining an outlet. The valve assembly also includes a float disposed inside the valve body and is movable between a first position and a second position relative to the valve body. The valve assembly further includes a support coupled to the float and is movable with the float between the first and second positions. The valve assembly also includes a sealing member attached to the support and has an engagement portion spaced from the seat when the float is in the first position and engaging the seat when the float is in the second position.

### TECHNICAL FIELD

The present teachings generally include a valve assembly.

### BACKGROUND

Fuel tank valves that function to vent vapors from a fuel tank are known. Generally, the vapors are vented to a canister that stores the vapors and is periodically purged. Fuel tank valves are configured to prevent liquid fuel in the fuel tank from entering the canister even when a vehicle is parked on a grade.

### SUMMARY

The present teachings generally include a valve assembly. The valve assembly includes a valve body and a seat defining an outlet. The valve assembly also includes a float disposed inside the valve body. The float is movable between a first position and a second position relative to the valve body. The valve assembly further includes a support coupled to the float. The support is movable with the float between the first and second positions. The valve assembly also includes a sealing member attached to the support. The sealing member has an engagement portion spaced from the seat when the float is in the first position and engaging the seat when the float is in the second position. The engagement portion includes a first surface and a second surface opposing the first surface. The first surface faces the seat and the second surface abuts the support. The engagement portion completely extends from the first surface to the second surface.

The present teachings also generally include another valve assembly. The valve assembly includes a valve body and a seat defining an outlet. The seat is a separate component from the valve body and is attachable to the valve body. The valve assembly also includes a float disposed inside the valve body. The float is movable between a first position and a second position relative to the valve body. The valve assembly further includes a support coupled to the float. The support is movable with the float between the first and second positions. The valve assembly also includes a sealing member attached to the support. The sealing member has an engagement portion spaced from the seat when the float is in the first position and engaging the seat when the float is in the second position. The sealing member includes a plurality of extensions spaced from each other and an outer periphery. Each of the extensions includes an inner side and an outer side. At least a portion of the outer side of each of the extensions extends non-tangentially from the outer periphery.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic partial cross-sectional side illustration of a valve assembly internally mounted to a tank, with a vapor control structure cooperating with the valve assembly.

FIG. 2 is a schematic partial cross-sectional side illustration of the valve assembly externally mounted to the tank, with the vapor control structure cooperating with the valve assembly.

FIG. 3 is a schematic perspective exploded view of the valve assembly.

FIG. 4 is a schematic cross-sectional view of the valve assembly with a float in a first position and an engagement portion of a sealing member in an initial position.

FIG. 5 is a schematic fragmentary cross-sectional view of the valve assembly with the float in a second position and the engagement portion of the sealing member in a displaced position.

FIG. 6 is a schematic cross-sectional view of a support and the sealing member.

FIG. 7 is a schematic partially exploded perspective view of another valve assembly.

FIG. 8 is a schematic cross-sectional view of the valve assembly of FIG. 7.

FIG. 9 is a schematic fragmentary enlarged cross-sectional view of a seat of the valve assembly of FIG. 7.

FIG. 10 is a schematic fragmentary cross-sectional view of an engagement portion of a sealing member in a displaced position when a float is in a second position of the embodiment of FIG. 7.

FIG. 11 is a schematic partially exploded perspective view of the sealing member and the float of FIG. 7.

FIG. 12 is a schematic exploded perspective view of the sealing member and a support of FIG. 7.

FIG. 13 is a schematic end view of the sealing member and the support coupled to the float.

FIG. 14 is a schematic exploded perspective view of the valve assembly of FIG. 7 further including a head valve.

FIG. 15 is a schematic partially exploded perspective view of yet another valve assembly.

FIG. 16 is a schematic cross-sectional view of the valve assembly of FIG. 15.

FIG. 17 is a schematic top view of the valve assembly of FIG. 15, with the cross-section of FIG. 16 taken from lines 16-16 of FIG. 17.

FIG. 18 is a schematic enlarged perspective view of an adaptor piece from FIG. 15.

FIG. 19 is a schematic cross-sectional view of a valve assembly with a sealing member of another configuration.

FIG. 20 is a schematic fragmentary cross-sectional view of the valve assembly of FIG. 19, with the sealing member of FIG. 19.

FIG. 21 is a schematic cross-sectional view of a support and the sealing member of FIG. 19.

FIG. 22 is a schematic illustration of the seat defining an outlet of another configuration.

FIG. 23 is a schematic enlarged and rotated view of the seat and the outlet taken from circle 23 in FIG. 22.

FIG. 24 is a schematic cross-sectional view of another sealing member.

FIG. 25 is a schematic cross-sectional view of yet another sealing member.

FIG. 26 is a schematic cross-sectional view of yet another sealing member.

### DETAILED DESCRIPTION

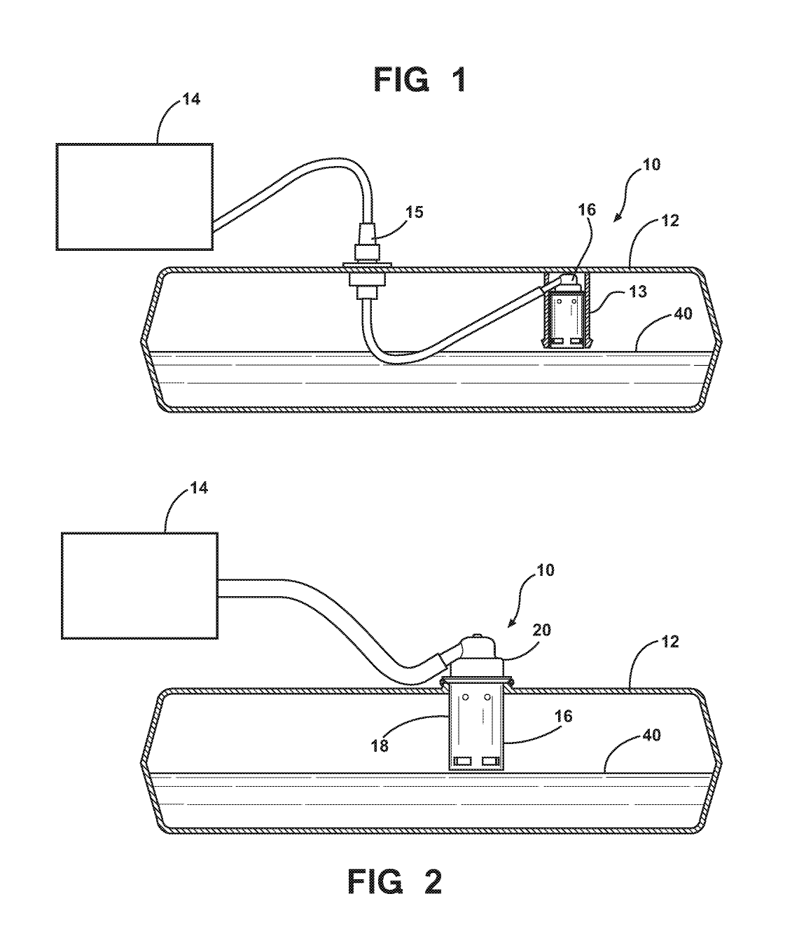

Referring to the Figures, wherein like numerals indicate like or corresponding parts throughout the several views, a valve assembly 10 for a tank 12 of a vehicle is generally shown in FIGS. 1 and 2. In certain embodiments, the tank 12 can be a fuel tank 12 of the vehicle. Therefore, liquid fluid, such as fuel can be stored in the tank 12. It is to be appreciated that the valve assembly 10 can be utilized with tanks 12 other than fuel tanks 12. For example, the valve assembly 10 can be mounted to a urea tank in a vehicle. Therefore, other liquid fluids can be stored in the tank 12.

Generally, the valve assembly 10 is attached to the tank 12. The valve assembly 10 can be internally mounted to the tank 12 as shown in FIG. 1 or externally mounted to the tank 12 as shown in FIG. 2. For the internally mounted valve assembly 10, the assembly 10 can be supported by a bracket 13 inside the tank 12. For the externally mounted valve assembly 10, a portion of the valve assembly 10 is disposed inside the tank 12 and another portion of the valve assembly 10 is disposed outside of the tank 12 as shown in FIG. 2. The features of the valve assembly 10 discussed herein are the same for the internally mounted valve assembly 10 and the externally mounted valve assembly 10. It is to be appreciated that other components can be utilized with the internally or externally mounted valve assembly 10, such as, for example, a nipple 15 (see FIG. 1) that can extend through the tank 12 to couple the internally mounted valve assembly 10 inside the tank 12 to components outside of the tank 12.

Generally, the valve assembly 10 allows vapor that build up in the tank 12 to be vented out of the tank 12 to a vapor control structure 14. The vapor control structure 14 can store the vapor received from the tank 12 and can be periodically purged. Therefore, under certain conditions, the vapors move or flow from the tank 12 through the valve assembly 10 and into the vapor control structure 14. It is to be appreciated that the vapor control structure 14 can be referred to as a canister, such as a charcoal canister.

Referring to FIGS. 1-3, the valve assembly 10 includes a valve body 16 adapted to be attached to the tank 12. Simply stated, the valve body 16 is attached or mounted to the tank 12 either internally or externally as discussed above. For the externally mounted valve assembly 10 as shown in FIG. 2, a first portion 18 of the valve body 16 is disposed inside of the tank 12 and a second portion 20 of the valve body 16 is disposed outside of the tank 12. Therefore, generally, the vapors vented out of the tank 12 move or flow from the first portion 18 into the second portion 20 and out to the vapor control structure 14.

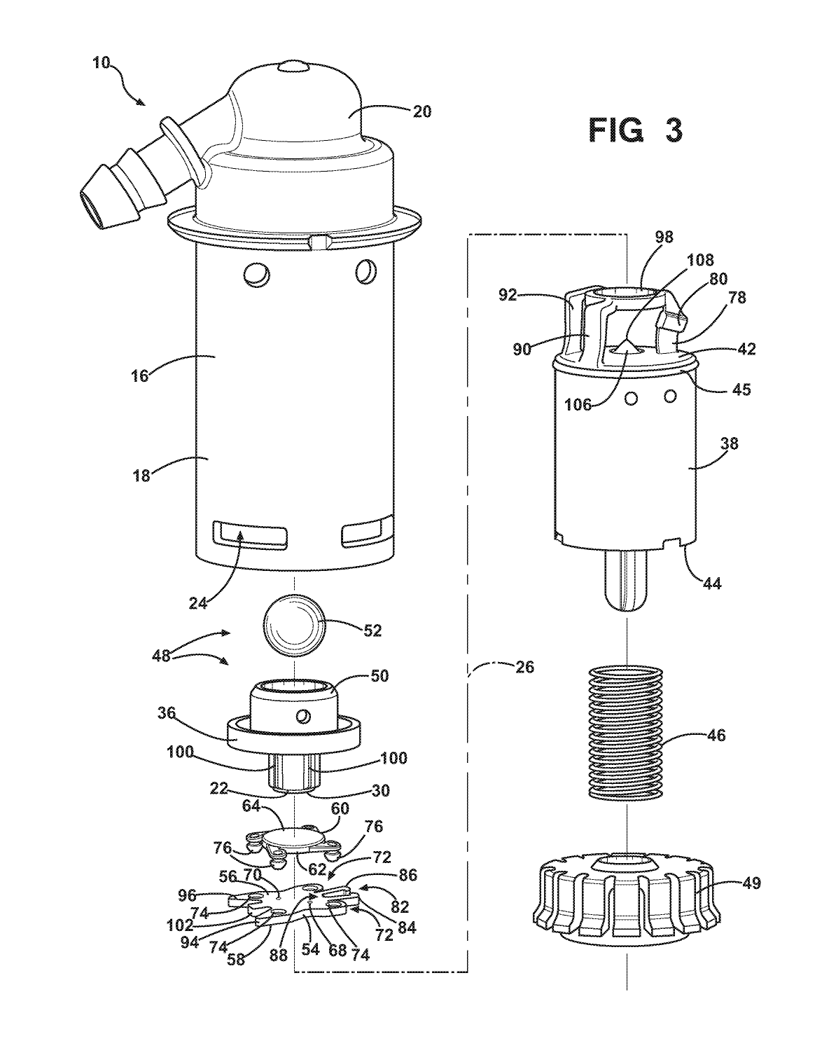

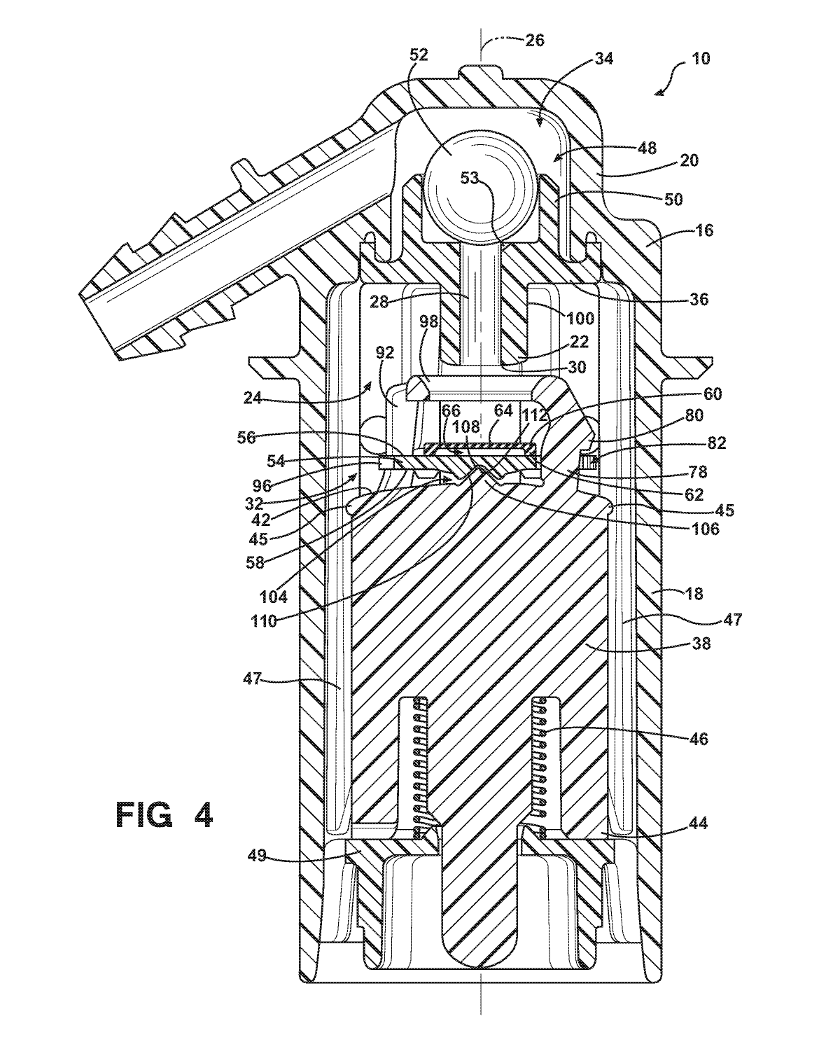

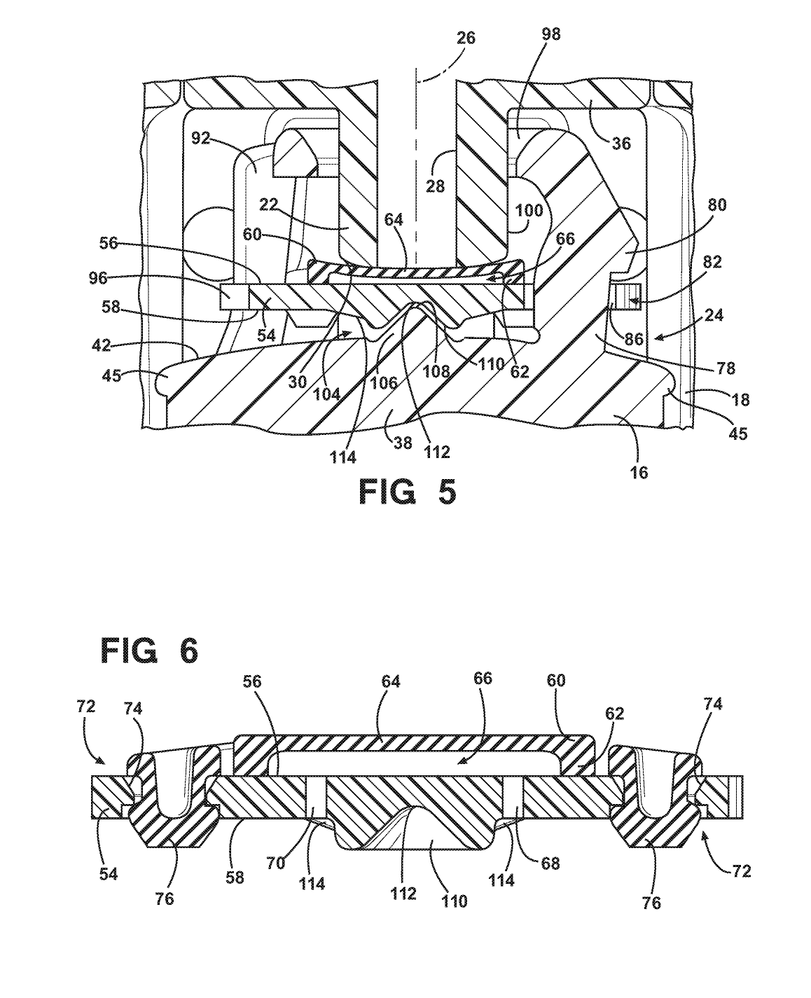

Turning to FIGS. 3-5, the valve body 16 includes a seat 22 disposed inside the valve body 16. The seat 22 will be referred to as a first seat 22 for the below discussion. The valve body 16 can define a cavity 24 along a longitudinal axis 26, with the first seat 22 disposed in the cavity 24. The first seat 22 can be coupled to the first and/or second portion 18, 20 of the valve body 16. As shown in FIGS. 4 and 5, in certain embodiments, the first seat 22 can be attached to the second portion 20 of the valve body 16. The first seat 22 can be attached to the first and/or second portion 18, 20 by a snap fit, fasteners, tabs, etc. It is to be appreciated that the first seat 22 can be integrally formed with the valve body 16. In other words, the first seat 22 and the valve body 16 can be formed of one piece.

As best shown in FIG. 4, generally, the first seat 22 defines an outlet 28 for venting the tank 12. Therefore, the outlet 28 and the cavity 24 can be in fluid communication with each other and in fluid communication with the vapor control structure 14 for venting the vapor out of the tank 12 and into the vapor control structure 14. The outlet 28 can be disposed along the longitudinal axis 26. The first seat 22 can present an end face 30 further defining the outlet 28 and will be discussed further below.

The first seat 22 can be attached or mounted to the valve body 16 such that the cavity 24 is split into a first cavity portion 32 and a second cavity portion 34. Generally, the first cavity portion 32 is disposed in the first portion 18 of the valve body 16 and the second cavity portion 34 is disposed in the second portion 20 of the valve body 16. Therefore, the vapors move or flow from the first cavity portion 32 through the outlet 28 and into the second cavity portion 34. Simply stated, the outlet 28 is disposed between the first and second cavity portions 32, 34.

The valve body 16 can further include a plate 36 supporting the first seat 22 and further splitting or separating the cavity 24 into the first and second cavity portions 32, 34. The first seat 22 can extend outwardly from the plate 36 into the first cavity portion 32. The plate 36 can be coupled to the first and/or second portions 18, 20 of the valve body 16 such that the plate 36 is sealed to the first and/or second portions 18, 20. Therefore, fluid cannot seep between the plate 36 and the valve body 16. As shown in FIG. 4, the plate 36 can be attached to the second portion 20 of the valve body 16. The plate 36 can be attached to the first and/or second portions 18, 20 by a snap fit, fasteners, tabs, etc. It is to be appreciated that the plate 36 and the first seat 22 can be integrally formed to each other. In other words, the plate 36 and the first seat 22 can be formed of one piece. Furthermore, it is to be appreciated that the plate 36, the first seat 22 and the valve body 16 can be integrally formed to each other or formed of one piece.

Referring to FIGS. 3 and 4, the valve assembly 10 further includes a float 38 disposed inside the valve body 16. More specifically, the float 38 is disposed in the cavity 24 and is movable relative to the first seat 22. Generally, the float 38 can be movable along the longitudinal axis 26. Specifically, the float 38 is movable between a first position and a second position relative to the valve body 16 in response to a liquid fluid level 40 (see FIGS. 1 and 2) inside the tank 12. In other words, when the float 38 is combined with a biasing force, which is discussed further below, the float 38 is buoyant in the liquid fluid, such as fuel, stored in the tank 12. Thus, the float 38 can move along the longitudinal axis 26 depending on the liquid fluid level 40 of the fuel inside the tank 12. For example, if the liquid fluid level 40 rises, the float 38 moves toward the first seat 22 and the plate 36. As another example, if the liquid fluid level 40 descends, the float 38 moves away from the first seat 22 and the plate 36. The float 38 is shown in the first position in FIG. 4 and the float 38 is shown in the second position in FIG. 5.

Continuing with FIGS. 3 and 4, the float 38 can include a first end 42 and a second end 44 spaced from each other along the longitudinal axis 26. Generally, the first end 42 faces the first seat 22 and the second end 44 opposes the first end 42. More specifically, the first end 42 of the float 38 and the end face 30 of the first seat 22 face each other. The float 38 can include a bulge 45 disposed between the first and second ends 42, 44, with the bulge 45 surrounding the float 38 to assist in aligning or centering the float 38 relative to the first seat 22.

Generally, the bulge 45 extends outwardly away from the longitudinal axis 26 and faces the inner surface of the first portion 18 of the valve body 16. In one embodiment, the bulge 45 is disposed adjacent to the first end 42 of the float 38. For example, the bulge 45 assists in aligning or centering the float 38 along the longitudinal axis 26 as the float 38 moves between the first and second positions, which aligns or centers the float 38 relative to the first seat 22. Therefore, the bulge 45 can minimize transverse movement of the float 38 relative to the longitudinal axis 26. In other words, the bulge 45 and the valve body 16 cooperate to minimize play in the float 38. It is to be appreciated that the valve body 16 can include one or more fins 47 disposed in the first cavity portion 32 such that the fins 47 are disposed between the inner surface of the valve body 16 and the float 38. Therefore, the bulge 45 can selectively engage the valve body 16 or the fins 47 during movement of the float 38 between the first and second positions. It is to be appreciated that the bulge 45 and the fins 47 can be any suitable configuration.

The valve assembly 10 can further include a biasing member 46 engaging the second end 44 of the float 38 to continuously bias the float 38 toward the first seat 22 or the plate 36. In other words, the biasing member 46 applies the biasing force to the float 38 as discussed above. The biasing force overcomes the weight of the float 38 and frictional forces between the float 38 engaging the fins 47 as the float 38 moves between the first and second positions. The valve body 16 can include an end cap 49 that generally closes the first cavity portion 32 and the biasing member 46 can engage the end cap 49. The end cap 49 remains stationary as the float 38 moves between the first and second positions. The end cap 49 generally contains the float 38 inside the first cavity portion 32 and provides a surface for the biasing member 46 to react against. The end cap 49 is spaced from the first seat 22 and can define an opening for an extension of the float 38 to be movable through the opening. It is to be appreciated that in a vehicle roll-over situation, the float 38 will move to the second position without the buoyancy of the float 38 affecting the float's position due to the biasing force applied to the float 38 overcoming the buoyancy of the float 38, the weight of the float 38, and the frictional forces between the float 38 engaging the fins 47. Therefore, when in the vehicle roll-over situation, the biasing member 46 assists in maintaining the float 38 in the second position. In certain embodiments, the biasing member 46 can be a spring, such as a coil spring. It is to be appreciated that the biasing member 46 can be any suitable configuration to continuously bias the float 38 toward the first seat 22.

Optionally, as shown in FIGS. 3 and 4, the valve assembly 10 can include a head valve 48 disposed in the second cavity portion 34. The head valve 48 can include a second seat 50 opposing the first seat 22, with the second seat 50 extending outwardly from the plate 36 into the second cavity portion 34. It is to be appreciated that the plate 36 and the second seat 50 can be integrally formed to each other. In other words, the plate 36 and the second seat 50 can be formed of one piece. Furthermore, it is to be appreciated that the plate 36, the first and second seats 22, 50 and the valve body 16 can be integrally formed to each other or formed of one piece. It is to be appreciated that in a urea tank application, the head valve 48 can be eliminated.

The head valve 48 can also include a blocking member 52 movably disposed in the second seat 50 such that the blocking member 52 selectively closes the outlet 28. Generally, the blocking member 52 rests in the second seat 50 to close the outlet 28 while the float 38 is in the first position. The blocking member 52 moves away from the second seat 50 to open the outlet 28 when vapor pressure in the tank 12 exceeds a predetermined pressure while the float 38 is in the first position. When the blocking member 52 moves away from the second seat 50, vapors can vent through the outlet 28 into the vapor control structure 14. For example, the blocking member 52 can move away from the second seat 50 to open the outlet 28 during refueling when there is a large pressure differential between the tank 12 and the second cavity portion 34. In certain embodiments, the blocking member 52 can be a ball as shown in FIGS. 3 and 4. It is to be appreciated that the blocking member 52 can be any suitable configuration. The head valve 48 can also be referred to as a pressure relief valve.

The second seat 50 can define a notch 53 (see FIG. 4) adjacent to the outlet 28 to allow a small amount of fluid communication between the first and second cavity portions 32, 34 when the blocking member 52 engages the outlet 28. In other words, when the blocking member 52 engages the outlet 28, the notch 53 allows a small amount of vapor to communicate between the first and second cavity portions 32, 34 such that small pressure differentials between the first and second cavity portions 32, 34 can be equalized. Generally, the notch 53 can be referred to as a bleed notch 53.

Referring to FIGS. 3, 4 and 6, the valve assembly 10 also includes a support 54 coupled to the float 38. In certain embodiments, the support 54 is coupled to the first end 42 of the float 38. The support 54 is movable with the float 38 between the first and second positions. Furthermore, the support 54 is movable independently of the float 38 as discussed further below. The support 54 can have a first side 56 and a second side 58 opposing the first side 56 which is also discussed further below.

In addition, continuing with FIGS. 3, 4 and 6, the valve assembly 10 includes a sealing member 60 attached to the support 54. It is to be appreciated that the sealing member 60 and the support 54 can be separate components attached to one another or integrally formed to each other such that the sealing member 60 and the support 54 are formed of one-piece. The sealing member 60 has a base 62 abutting the support 54. In certain embodiments, the base 62 abuts one of the first and second sides 56, 58 of the support 54. In one embodiment, the base 62 abuts the first side 56 of the support 54. The support 54 and the sealing member 60 cooperate to define a drum seal or a flapper. The drum seal 54, 60 provides improved opening and closing features of the outlet 28. For example, the drum seal 54, 60 fully opens quickly when the float 38 moves from the second position back to the first position to provide fully open fluid communication through the outlet 28. In other words, the drum seal 54, 60 peels away from the first seat 22 crisply such that the sealing member 60 does not flutter partially engaging the first seat 22 and thus partially covering the outlet 28. Said differently, the drum seal 54, 60 pops off of the first seat 22 as the float 38 moves from the second position back to the first position.

The sealing member 60 also has an engagement portion 64 supported by the base 62 to define a space 66 between the engagement portion 64 and the support 54 to allow movement of the engagement portion 64 between an initial position when the float 38 is in the first position and a displaced position when the float 38 is in the second position. More specifically, the space 66 can be defined between the engagement portion 64 and one of the first and second sides 56, 58 of the support 54 to allow movement of the engagement portion 64 between the initial position and the displaced position. Generally, the float 38 is in the first position when the engagement portion 64 is spaced from the first seat 22 to allow fluid communication through the outlet 28. The float 38 is in the second position when the engagement portion 64 engages the first seat 22 such that the engagement portion 64 seals the outlet 28 to minimize fluid communication through the outlet 28, and more specifically, minimize fuel or vapor in the tank 12 from entering the vapor control structure 14. Therefore, for example, when the float 38 is in the second position, the engagement portion 64 engages the first seat 22 such that the engagement portion 64 seals the outlet 28 to prevent fuel or vapor in the tank 12 from entering the vapor control structure 14. The sealing member 60 closes the outlet 28 quickly and crisply such that the sealing member 60 does not flutter partially engaging the first seat 22 and thus partially covering the outlet 28.

In various embodiments, as shown in FIGS. 4-6, the engagement portion 64 and the first side 56 of the support 54 define the space 66. Furthermore, in certain embodiments, the base 62, the engagement portion 64 and the first side 56 of the support 54 further define the space 66 or pocket as best shown in FIG. 6. Referring to FIG. 4, the engagement portion 64 is spaced from the first seat 22 when in the initial position to allow fluid communication through the outlet 28. As shown in FIG. 5, the engagement portion 64 engages the first seat 22 when in the displaced position such that the space 66 decreases in size and the engagement portion 64 deforms about the first seat 22 to cover the outlet 28 and minimize fluid communication through the outlet 28. Therefore, if the vehicle is partially/fully rolled over, the float 38 can move to the second position and the engagement portion 64 to the displaced position, and thus the engagement portion 64 will engage the first seat 22 to seal the outlet 28, which minimizes fuel and vapor in the tank 12 from entering into the vapor control structure 14. Furthermore, if the liquid fluid level 40 is relatively high in the tank 12 and/or the vehicle is on a grade, the liquid fluid or fuel shifts in the tank 12 which can also cause the float 38 to move to the second position and the engagement portion 64 to the displaced position, and thus the engagement portion 64 will engage the first seat 22 to seal the outlet 28, which minimizes fuel and vapor in the tank 12 from entering into the vapor control structure 14. Liquid fluid or fuel could affect or saturate the vapor control structure 14 if the liquid fluid or fuel reaches the vapor control structure 14. Therefore, for example, the engagement portion 64 and the first seat 22 cooperate to seal the outlet 28 when in the displaced position to prevent liquid fluid or fuel in the tank 12 from entering the vapor control structure 14.

More specifically, the engagement portion 64 engages the end face 30 of the first seat 22 when in the displaced position. Therefore, when the engagement portion 64 is in the displaced position, the engagement portion 64 covers the end face 30 of the first seat 22 to minimize fluid communication through the outlet 28. Simply stated, the engagement portion 64 flexes or deforms about the first seat 22, and more specifically, flexes or deforms about the end face 30 of the first seat 22, to cover the outlet 28 and minimize fuel and vapor in the tank 12 from entering into the vapor control structure 14. Therefore, for example, the engagement portion 64 can engage the end face 30 of the first seat 22 to prevent fuel and vapor in the tank 12 from entering the vapor control structure 14. The engagement portion 64 can be deformed by the first seat 22 such that the engagement portion 64 remains spaced from the support 54, and more specifically, spaced from the first side 56 of the support 54. Alternatively, the engagement portion 64 can be deformed by the first seat 22 until the engagement portion 64 engages the first side 56 of the support 54 such that the engagement portion 64 is sandwiched between the end face 30 of the first seat 22 and the first side 56 of the support 54.

At least a segment of the sealing member 60 can be formed of a flexible material. In certain embodiments, the entire sealing member 60 is formed of the flexible material. For example, the segment of the sealing member 60 can be the engagement portion 64. Therefore, the sealing member 60 or the engagement portion 64 can be formed of an elastomer. One suitable elastomer is a fluorinated elastomer. In certain embodiments, the elastomer is fluorosilicone. It is to be appreciated that any other suitable flexible material can be utilized.

As mentioned above, the sealing member 60 can be formed of flexible material, therefore, the sealing member 60 or the engagement portion 64 is elastically deformable or reversibly deformable. Said differently, the sealing member 60 or the engagement portion 64 is resilient, and thus, after deformation, the sealing member 60/engagement portion 64 returns to its original configuration. Furthermore, the flexible material for the base 62 can be thicker than the flexible material for the engagement portion 64 such that the engagement portion 64 deforms more readily than the base 62. Therefore, when the engagement portion 64 is in the displaced position, the engagement portion 64 is deformed, and when the engagement portion 64 is in the initial position, the engagement portion 64 returns back to its original configuration. Thus, if the vehicle is partially/fully rolled over, the float 38 can move to the second position and the engagement portion 64 to the displaced position such that the engagement portion 64 deforms around the end face 30 of the first seat 22 to seal the outlet 28, which minimizes fuel and vapor in the tank 12 from entering into the vapor control structure 14. Furthermore, if the liquid fluid level 40 is relatively high in the tank 12 and the vehicle is on the grade, the liquid fluid or fuel shifts in the tank 12 which can also cause the float 38 to move to the second position and the engagement portion 64 to the displaced position such that the engagement portion 64 deforms around the end face 30 of the first seat 22 to seal the outlet 28, which minimizes fuel and vapor in the tank 12 from entering into the vapor control structure 14. In addition, if the vehicle is being driven such that the fuel is sloshing around in the tank 12, the engagement portion 64 can engage the end face 30 of the first seat 22 to seal the outlet 28 to minimize fuel in the tank 12 from entering the vapor control structure 14. As discussed above, liquid fluid or fuel could affect or saturate the vapor control structure 14 if the liquid fluid or fuel reaches the vapor control structure 14. Therefore, for example, the engagement portion 64 and the end face 30 of the first seat 22 cooperate to seal the outlet 28 when in the displaced position to prevent liquid fluid or fuel in the tank 12 from entering the vapor control structure 14.

Optionally, the engagement portion 64 can include a treated surface facing the first seat 22 to selectively engage the end face 30 of the first seat 22. In other words, the treated surface is disposed on the side of the engagement portion 64 that faces the end face 30 of first seat 22. The treated surface can assist in allowing the engagement portion 64 to peel away from the first seat 22 when the sealing member 60 is moving to the initial position, and more specifically, peel away from the end face 30 of the first seat 22. In other words, the treated surface can assist in quickly peeling away the sealing member 60 from the first seat 22 such that the sealing member 60 does not flutter partially engaging the first seat 22. The treated surface can be textured and/or have a coating applied thereon. For example, the engagement portion 64 can be micro-machined to create the textured surface. The textured surface can be ribs, knobs, moguls, etc. As another example, the engagement portion 64 can be a low friction treated surface or a liquid-repellant treated surface.

Turning to FIG. 6, the support 54 can define a first hole 68 through the first and second sides 56, 58 such that the space 66 is in fluid communication with inside of the valve body 16 to equalize pressure between the space 66 and inside of the valve body 16 when the engagement portion 64 moves between the initial and displaced positions. More specifically, the first hole 68 equalizes pressure between the space 66 and the cavity 24, and specifically equalizes pressure between the space 66 and the first cavity portion 32 of the cavity 24. For example, when the engagement portion 64 engages the first seat 22, fluid (gaseous and/or liquid fluid) is expelled out of the space 66 through the first hole 68 as the space 66 decreases in size. When the engagement portion 64 disengages the first seat 22, fluid enters the space 66 through the first hole 68 such that the engagement portion 64 returns to its original configuration in the initial position.

Continuing with FIG. 6, additionally, the support 54 can define a second hole 70 through the first and second sides 56, 58 such that the space 66 is in fluid communication with inside of the valve body 16 to equalize pressure between the space 66 and inside of the valve body 16 when the engagement portion 64 moves between the initial and displaced positions. More specifically, the second hole 70 equalizes pressure between the space 66 and the cavity 24, and specifically equalizes pressure between the space 66 and the first cavity portion 32 of the cavity 24. Generally, the first and second holes 68, 70 are spaced from each other. It is to be appreciated that any suitable number of holes 68, 70 can be utilized for equalizing pressure between the space 66 and the cavity 24. Furthermore, in addition to, or alternatively to having one or more holes 68, 70, the first side 56 of the support 54 can define one or more serrations, saw teeth, etc. along the base 62 of the sealing member 60 to equalize pressure between the space 66 and the cavity 24.

As shown in FIG. 6, the base 62 of the sealing member 60 surrounds the first and second holes 68, 70. Therefore, as indicated above, fluid communication between the space 66 and the cavity 24 is provided through the first and/or second holes 68, 70. As such, when the engagement portion 64 engages the first seat 22, fluid (gaseous and/or liquid fluid) is expelled out of the space 66 through the first and/or second holes 68, 70 as the space 66 decreases in size. When the engagement portion 64 disengages the first seat 22, fluid enters the space 66 through the first and/or second holes 68, 70 such that the engagement portion 64 returns to its original configuration in the initial position. Simply stated, the first and second holes 68, 70 provide bleed holes for the space 66.

Turning to FIGS. 3 and 6, generally, the support 54 can define a mounting portion 72 to attach the sealing member 60 to the support 54. In certain embodiments, the mounting portion 72 is further defined as plurality of mounting portions 72 cooperating with the sealing member 60 to secure the sealing member 60 to the support 54. The mounting portions 72 can be spaced from each other and can be any suitable configuration. For example, as shown in FIGS. 3 and 6, each of the mounting portions 72 can define an aperture 74 such that a plurality of parts of the sealing member 60 can be disposed through respective apertures 74. Furthermore, the first and second holes 68, 70 are spaced from the mounting portion 72, and more specifically, spaced from the mounting portions 72.

Continuing with FIGS. 3 and 6, the sealing member 60 can include coupling members 76, such as feet, spaced from each other, with each of the coupling members 76 disposed in respective apertures 74. Therefore, the parts as discussed above can be defined as the coupling members 76/feet. The coupling members 76 can be deformed to be inserted through the respective apertures 74. Therefore, when the sealing member 60 is attached to the support 54, the base 62 surrounds the first and second holes 68, 70. It is to be appreciated that the sealing member 60 can be attached to the support 54 by adhesive, over-molding, fasteners such as hooks, staples, dovetails, snap-locks, etc., or any other suitable method.

Referring to FIGS. 3 and 4, the float 38 can include an attachment member 78 extending outwardly from the first end 42. In certain embodiments, the attachment member 78 is elongated and extends toward the plate 36 or the second cavity portion 34. It is to be appreciated that the attachment member 78 can be any suitable configuration.

The attachment member 78 can include a stop 80 spaced from the first end 42, with the support 54 movable along the longitudinal axis 26 between the first end 42 and the stop 80 independently of movement of the float 38 between the first and second positions. The stop 80 limits the amount of movement of the support 54 along the longitudinal axis 26 while allowing the engagement portion 64 to peel away from the first seat 22 under certain conditions. This independent movement allows the drum seal 54, 60 to quickly open and close without fluttering as discussed above. One or more sections of the stop 80 can be flat, arcuate, sloped or angled, etc. It is to be appreciated that the stop 80 can be any suitable configuration.

The support 54 can include a coupler 82 (see FIGS. 3 and 4) engaging the attachment member 78 to movably couple the support 54 to the float 38. The coupler 82 can include a first finger 84 and a second finger 86 cooperating with each other to receive the attachment member 78 therebetween. Specifically, the first and second fingers 84, 86 are spaced from each other to define a gap 88 therebetween. The attachment member 78 is disposed in the gap 88 between the fingers 84, 86 such that the coupler 82 couples the support 54 to the float 38. The first and second fingers 84, 86 can bias back and forth around the attachment member 78 to attach or detach the support 54 from the attachment member 78. Under certain conditions, the coupler 82 can selectively engage the stop 80. The coupler 82 can be any suitable configuration and can be coupled to the attachment member 78 differently than discussed above. For example, the attachment member 78 can define a slot with the coupler 82 including one or more posts, fingers, hooks, or protrusions disposed through the slot to couple the support 54 to the attachment member 78.

The float 38 can further include a first column 90 and a second column 92, with the attachment member 78 and the first and second columns 90, 92 spaced from each other radially relative to the longitudinal axis 26. The support 54 can include a first leg 94 and a second leg 96 spaced from each other and each spaced from the coupler 82. The first leg 94 can selectively engage the first column 90 and the second leg 96 can selectively engage the second column 92 to limit rotational movement of the support 54 about the longitudinal axis 26 to position the engagement portion 64 of the sealing member 60 relative to the first seat 22. More specifically, the coupler 82 can engage the attachment member 78, the first leg 94 can selectively engage the first column 90 and the second leg 96 can selectively engage the second column 92 to limit rotational movement of the support 54 about the longitudinal axis 26 to position the engagement portion 64 of the sealing member 60 relative to the first seat 22. The float 38, the first and second columns 90, 92, as well as the attachment member 78 can be integrally formed to each other or formed of one piece. Furthermore, the float 38, the first and second columns 90, 92 and the attachment member 78 can be formed of a plurality of pieces. It is to be appreciated that the first and second columns 90, 92 and the attachment member 78 can be attached to the float 38 by any suitable methods. Similarly, the support 54 and the first and second legs 94, 96 can be integrally formed to each other or formed of one piece. It is to be appreciated that the first and second legs 94, 96 can be attached to the support 54 by any suitable methods.

In certain embodiments, the float 38 can also include a ring 98 spaced from the first end 42 of the float 38 and attached to at least one of the attachment member 78 and the first and second columns 90, 92. Attached to at least one should be construed to include non-exclusive logical “or”, i.e., at least one of the attachment member 78 or the first column 90 or the second column 92 or combinations thereof. In one embodiment, as shown in FIG. 3, the ring 98 is attached to the attachment member 78 and the first and second columns 90, 92. The ring 98 surrounds the first seat 22 when the float 38 is in the second position to assist in aligning the float 38 along the longitudinal axis 26 and thus minimize movement of the float 38 transverse to the longitudinal axis 26. In other words, the ring 98 and the first seat 22 cooperate to minimize play in the float 38.

Optionally, the first seat 22 can include at least one rib 100, and more specifically can include a plurality of ribs 100 (see FIG. 3), extending outwardly away from the longitudinal axis 26. Generally, the ribs 100 further assist in aligning the float 38. Therefore, the ring 98 surrounds the first seat 22 and the rib or ribs 100 when the float 38 is in the second position to assist in aligning the float 38 along the longitudinal axis 26 and minimize movement of the float 38 transverse to the longitudinal axis 26. The ring 98, the attachment member 78 and the first and second columns 90, 92 can be integrally formed to each other or formed of one piece. It is to be appreciated that the ring 98 can be attached to the attachment member 78 and/or the first and second columns 90, 92 by any suitable methods.

As best shown in FIG. 3, the support 54 can include a tail 102 extending outwardly away from the first and second fingers 84, 86 for assisting in balancing the support 54. In other words, the tail 102 generally counter-balances the coupler 82, and more specifically, the tail 102, as well as the first and second legs 94, 96 generally counter-balance the coupler 82. In certain embodiments, the tail 102 is disposed between the first and second legs 94, 96 of the support 54. The tail 102 and the support 54 can be integrally formed to each other or formed of one piece. It is to be appreciated that the tail 102 can be attached to the support 54 by any suitable methods. It is to further be appreciated that the tail 102 can be any suitable configuration and location.

Turning to FIGS. 3-6, in certain embodiments, the float 38 and the support 54 includes a centering mechanism 104 for centering the support 54 relative to the longitudinal axis 26 to position the engagement portion 64 of the sealing member 60 relative to the first seat 22. More specifically, the centering mechanism 104 acts as a gimbal to position the engagement portion 64 of the sealing member 60 in a desired orientation relative to the end face 30 of the first seat 22. For example, the support 54 gimbals relative to the longitudinal axis 26 to substantially align the engagement portion 64 with the end face 30 of the first seat 22 across the outlet 28. Therefore, when the engagement portion 64 engages the end face 30, the outlet 28 is sealed by positioning or aligning the engagement portion 64. Generally, the support 54 can gimbal at a relatively low force such that the sealing member 60 remains in the desired orientation relative to the end face 30. As such, the centering mechanism 104 can position the engagement portion 64 to assist in tightly sealing the outlet 28 when the engagement portion 64 is in the displaced position. Gimballing of the support 54 can occur as the engagement portion 64 is proximal or close to engaging the end face 30 of the first seat 22. In certain embodiments, the support 54 can gimbal from about 5.0 degrees relative to the longitudinal axis 26. It is to be appreciated that the centering mechanism 104 can be designed to allow greater than or less than 5.0 degrees of gimballing relative to the longitudinal axis 26 when desired.

Additionally, the centering mechanism 104 can position the engagement portion 64 of sealing member 60 relative to the first seat 22 such that movement of the engagement portion 64 transverse to the longitudinal axis 26 is minimized when the engagement portion 64 is in the displaced position. Simply stated, the centering mechanism 104 can minimize lateral movement of the engagement portion 64. Said differently, the centering mechanism 104 can minimize sliding movement, i.e., side to side movement, of the engagement portion 64 relative to the end face 30 of the first seat 22 when the engagement portion 64 is in the displaced position. Minimizing sliding movement also minimizes liquid fluid or fuel in the tank 12 from entering the vapor control structure 14 when the engagement portion 64 is in the displaced position.

Continuing with FIGS. 3-6, in certain embodiments, the centering mechanism 104 can include a cone 106 extending outwardly from one of the float 38 and the support 54 to a distal end 108 coaxial with the longitudinal axis 26. Furthermore, in certain embodiments, the centering mechanism 104 can define a conical aperture 110 extending into the other one of the float 38 and the support 54 to a distal surface 112 coaxial with the longitudinal axis 26. The cone 106 is disposed in the conical aperture 110 to define the gimbal for centering the sealing member 60 relative to the longitudinal axis 26 to position the engagement portion 64 relative to the first seat 22. Simply stated, the cone 106 and the conical aperture 110 cooperate with each other. In certain embodiments, the outlet 28, the distal end 108 of the cone 106 and the distal surface 112 are coaxial with the longitudinal axis 26. Aligning the distal end 108, the distal surface 112 and the outlet 28 coaxially can assist in positioning the engagement portion 64, and thus, tightly sealing the outlet 28 when the engagement portion 64 is in the displaced position. Additionally, aligning the distal end 108, the distal surface 112 and the outlet 28 coaxially can lower the force that gimbals the support 54 relative to the longitudinal axis 26. Furthermore, the cone 106 and the conical aperture 110 cooperate to assist in minimizing sliding movement that also minimizes liquid fluid or fuel in the tank 12 from entering the vapor control structure 14 when the engagement portion 64 is in the displaced position. Additionally, the distal surface 112, and thus the distal end 108, are disposed proximal to the engagement portion 64 along the longitudinal axis 26 to minimize torque or angular force being applied to the centering mechanism 104 to allow the support 54 to gimbal as desired. It is to be appreciated that the cone 106 and the conical aperture 110 are shown spaced from each other in FIGS. 4 and 5 for illustrative purposes only and one skilled in the art would recognize that the cone 106 will engage the support 54 in the conical aperture 110 when in the illustrated positions. It is to be appreciated that the centering mechanism 104 can be other configurations than discussed above, for example, the cone 106 could be configured as a pin, etc.

In one embodiment, as best shown in FIGS. 4 and 5, the float 38 includes the cone 106 and the support 54 defines the conical aperture 110. Therefore, the cone 106 extends outwardly from the first end 42 of the float 38 and the conical aperture 110 extends into the support 54. More specifically, the cone 106 extends outwardly from the first end 42 of the float 38 toward the second side 58 of the support 54 and the second side 58 of the support 54 defines the conical aperture 110 extending toward the first side 56 away from the float 38. The cone 106 and the float 38 can be integrally formed to each other or formed of one piece. It is to be appreciated that the cone 106 can be attached to the first end 42 of the float 38 by any suitable methods.

Turning to FIG. 6, the support 54 can also include a reinforcing member 114 adjacent the conical aperture 110 to reinforce or strengthen the support 54 about the conical aperture 110. In certain embodiments, the reinforcing member 114 is further defined as a plurality of reinforcing members 114, with the reinforcing members 114 spaced from each other radially about the longitudinal axis 26. Each of the reinforcing members 114 are disposed adjacent the conical aperture 110 to reinforce or strengthen the support 54 about the conical aperture 110. Generally, the reinforcing members 114 extend from the second side 58 of the support 54. The reinforcing members 114 and the support 54 can be integrally formed to each other or formed of one piece. It is to be appreciated that the reinforcing members 114 can be attached to the support 54 by any suitable methods.

Optionally, various internal components of the valve assembly 10 discussed herein can be utilized in a valve body of another configuration. For example, the float 38 (with the attachment member 78, the columns 90, 92, a portion of the centering mechanism 104, etc.), the drum seal 54, 60, and/or the fins 47 can be designed to fit inside another valve body. As another example, the plate 36 with the first seat 22 including one or more ribs 100, and optionally the head valve 48, etc. can be designed to fit inside another valve body.

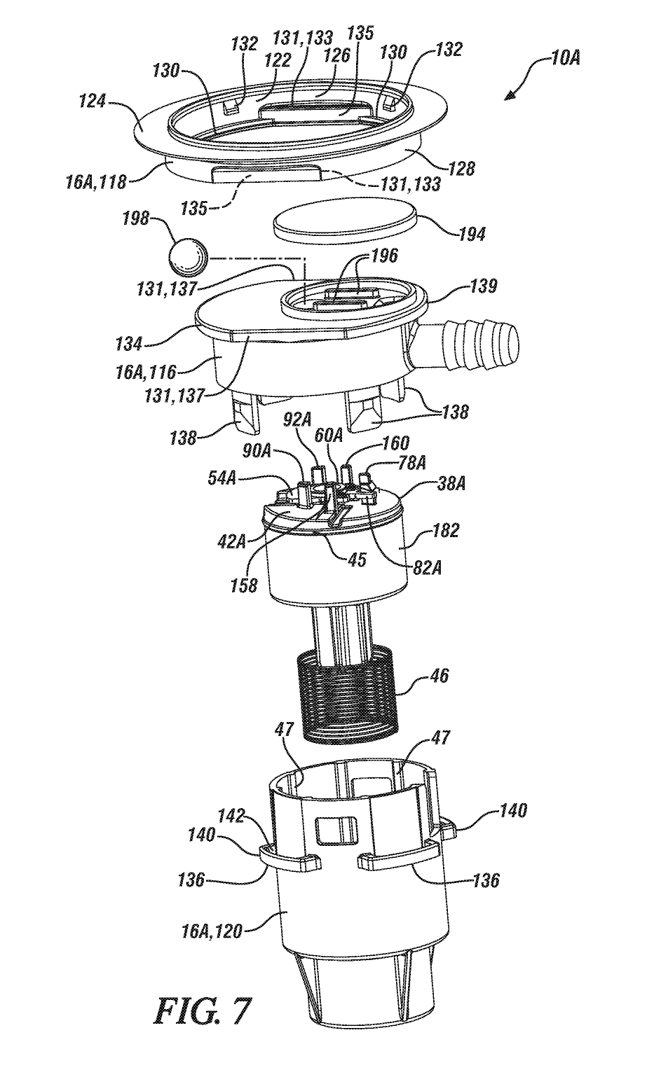

The valve assembly 10 can be designed with other features. As such, another embodiment of a valve assembly 10A is described below with regard to FIGS. 7-14. Similar or the same components will have the same reference numbers. The basic operation of the valve assembly 10A is the same as discussed above for the valve assembly 10. The below discussion focuses on the differences between the valve assemblies 10, 10A.

Generally, the valve assembly 10A is adapted to be attached to the tank 12. The valve assembly 10A can be attached to the tank 12 internally or externally as discussed above for the valve assembly 10. The valve assembly 10A can include the valve body 16A, which is adapted to be attached to the tank 12.

As best shown in FIG. 7, the valve assembly 10A can be formed of a plurality of pieces 116, 118, 120 attached to each other separately. Specifically, the valve body 16A can include a first body piece 116 and an adaptor piece 118 being a separate piece from the first body piece 116. Furthermore, the valve body 16A can include a second body piece 120 being a separate piece from the first body piece 116. The first body piece 116 is attachable to the adaptor piece 118 by a snap fit operation. Additionally, the first body piece 116 and the second body piece 120 are attachable to each other by another snap fit operation.

Once the first body piece 116 is attached to the adaptor piece 118 by the snap fit operation, the first body piece 116 is then permanently fixed to the adaptor piece 118, by for example, welding. The adaptor piece 118 can be attached to the tank 12, either directly or indirectly. The adaptor piece 118 can be welded to the tank 12. In certain embodiments, the valve body 16A is preassembled before being permanently fixed to the tank 12. Therefore, the adaptor piece 118 is attached to the first body piece 116 before being permanently fixed to the tank 12. In other embodiments, the adaptor piece 118 is permanently fixed to the tank 12 before attaching the first body piece 116 to the adaptor 118. By having the adaptor piece 118 being a separate piece from the first body piece 116 and attached to each other in the snap fit operation, an overmolding process can be eliminated as compared to a design where the valve body is one piece. Eliminating the overmolding process to make a one piece body can reduce costs.

Continuing with FIG. 7, the adaptor piece 118 can be defined as an adaptor ring having a central opening 122. The adaptor piece 118 can include a first flange 124 extending outwardly away from the central opening 122. The adaptor piece 118 can include an inner surface 126 facing the central opening 122 and an outer surface 128 opposing the inner surface 126. The first flange 124 can extend from the outer surface 128 away from the central opening 122. The outer surface 128 of the adaptor piece 118 and/or the first flange 124 can be attached to the tank 12 to secure the valve assembly 10A relative to the tank 12.

Again, continuing with FIG. 7, the inner surface 126 of the adaptor piece 118 can include one or more first attachment features 130, 132. For example, the first attachment features 130, 132 can include one or more first shoulders 130 and one or more first tabs 132 spaced from the first shoulder(s) 130. Furthermore, the first body piece 116 can include a second flange 134 which is snapped to the adaptor piece 118 inside the central opening 122 and between the first shoulder(s) 130 and the first tab(s) 132. For example, the first body piece 116 can be tilted relative to the central opening 122 at an angle not equal to 180 degrees with respect to the longitudinal axis 26. Specifically, as one non-limiting example, the second flange 134 can be tilted at the angle of approximately 45 degrees relative to the longitudinal axis 26 when inserted into the central opening 122. Once the second flange 134 is positioned in the central opening 122, the second flange 134 is then rotated to approximately 180 degrees relative to the longitudinal axis 26 to snap in place between the first shoulder(s) 130 and the first tab(s) 132 to attach the first body piece 116 to the adaptor piece 118.

Continuing with FIG. 7, the adaptor piece 118 and the first body piece 116 can each include an anti-rotation apparatus 131 that prevents rotation of the adaptor piece 118 and the first body piece 116 relative to each other. Specifically, the inner surface 126 of the adaptor piece 118 can include one or more protuberances 133 which protrude into the central opening 122. In certain embodiments, the protuberances 133 can be spaced from each other. For example, as shown in FIG. 7, the protuberances 133 can oppose each other in a spaced relationship. The protuberances 133 can be separated by the first shoulders 130. Furthermore, the protuberances 133 can include a flat surface 135 facing each other in the spaced relationship. The furthermost part of the protuberances 133 into the central opening 122 can be the location of the flat surfaces 135. Additionally, the second flange 134 can include one or more flats 137. Therefore, the flats 137 can be flat in configuration and separated from each other by portions of the second flange 134 that can be circular in configuration. The second flange 134 can include an outer perimeter 139 that includes the flats 137 and the circular configuration. Therefore, when the adaptor piece 118 is snapped into the first body piece 116, the flats 137 engage the flat surface 135 of the respective protuberances 133 which prevents rotation between the adaptor piece 118 and the first body piece 116. Furthermore, when the adaptor piece 118 is snapped into the first body piece 116, the portion of the second flange 134 that is circular in configuration is disposed between the respective first shoulders 130 and the respective first tabs 132. A portion of the inner surface 126, which cooperates with the portion of the second flange 134 that is circular, can also be circular in configuration. The anti-rotation apparatus 131 can include at least the protuberances 133 and the flats 137, and corresponding features discussed above.

As discussed above, the first body piece 116 and the second body piece 120 are attachable to each other. The first and second body pieces 116, 120 can each include one or more second attachment features 136, 138 (see FIG. 7) to secure the first and second body pieces 116, 120 together. For example, the second attachment features 136, 138 can include one or more second shoulders 136 and one or more second tabs 138, with respective second tab(s) 138 cooperating with respective second shoulder(s) 136 to attach the first and second body pieces 116, 120 together by engaging each other. For example, the second tabs 138 can bias as the second tabs 138 slide over respective second shoulders 136 to snap in place and secure the first and second body pieces 116, 120 together. In certain embodiments, the second tab(s) 138 can extend from the first body piece 116 and the second shoulder(s) 136 can extend from the second body piece 120. Alternatively, in other embodiments, the second tab(s) 138 can extend from the second body piece 120 and the second shoulder(s) 136 can extend from the first body piece 116. In yet other embodiments, one or more second shoulder(s) 136 and one or more second tab(s) 138 can extend from both of the first and second body pieces 116, 120 in an arrangement that the respective tab(s) 138 and the respective shoulder(s) 136 cooperate to secure the first and second body pieces 116, 120 together.

Continuing with FIG. 7, the second body piece 120 can include one or more attachment support(s) 140 extending outwardly from an outside of the second body piece 120, with one of the second shoulder(s) 136 supported by each of the attachment support(s) 140. Optionally, each of the attachment support(s) 140 can define a slot 142 that respective second tab(s) 138 can extend into such that the respective second tab(s) 138 engage the respective second shoulder(s) 136.

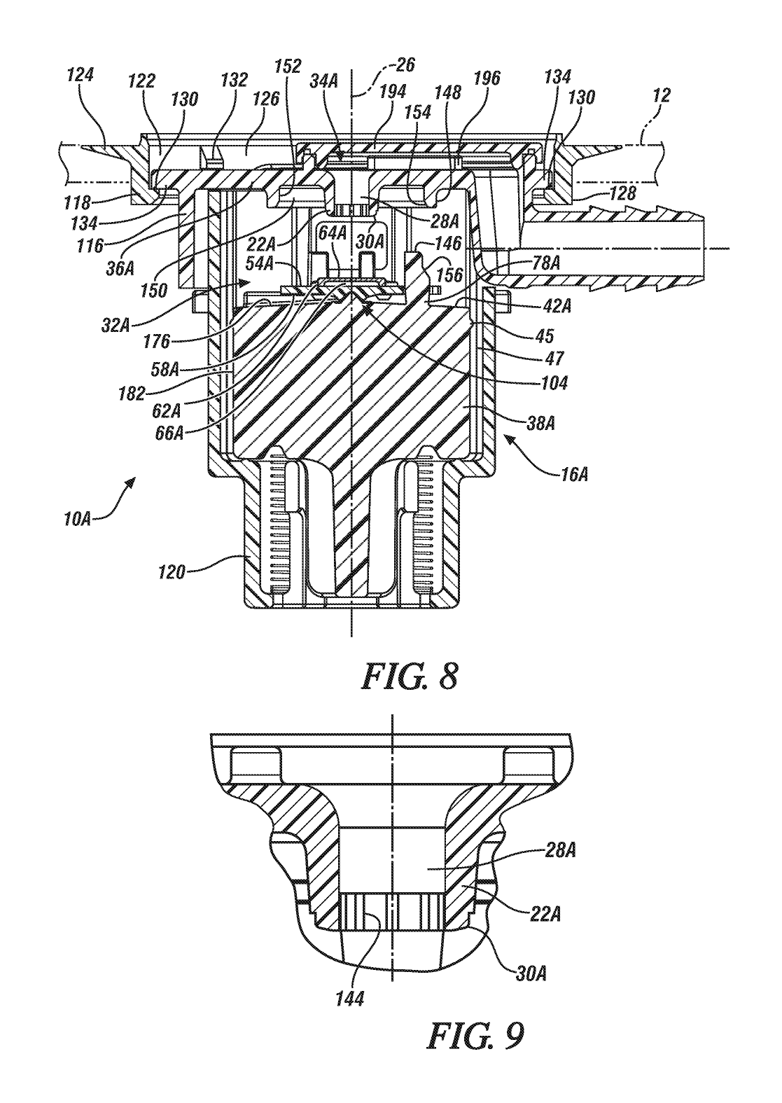

Turning to FIG. 8, the valve body 16A can include the seat 22A disposed inside the valve body 16A as discussed above for the valve assembly 10 with respect to the seat 22 and the valve body 16. The seat 22A can define the outlet 28A for venting the tank 12, as discussed above for the seat 22 and the outlet 28 of the valve assembly 10. The outlet 28A can be disposed along the longitudinal axis 26, which can include coaxial relative to the longitudinal axis 26, eccentric relative to the longitudinal axis 26 or spaced from and parallel to the longitudinal axis 26. When referring to the outlet 28 of the valve assembly 10 that can be along the longitudinal axis 26, that can also include coaxial relative to the longitudinal axis 26, eccentric relative to the longitudinal axis 26 or spaced from and parallel to the longitudinal axis 26. Furthermore, the valve assembly 10A can include the float 38A, the support 54A and the sealing member 60A, as discussed above with respect to the float 38, the support 54 and the sealing member 60 of the valve assembly 10.

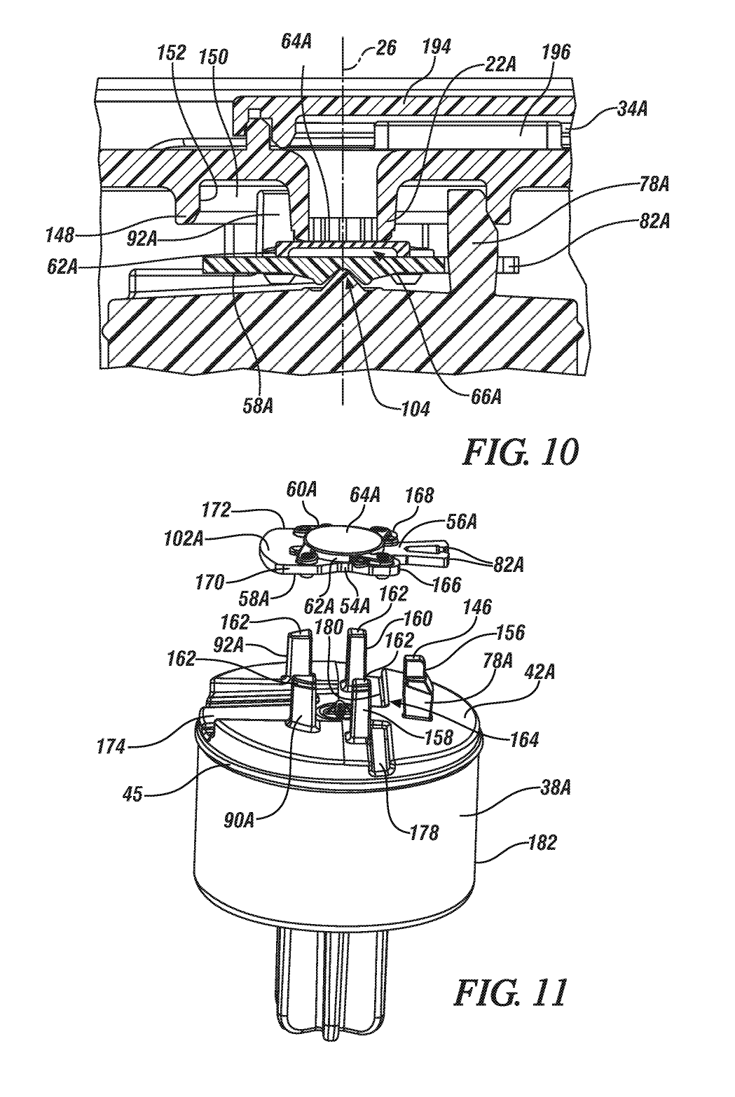

As similarly discussed above for the float 38 of the valve assembly 10, the float 38A (see FIG. 8) is disposed inside the valve body 16A and movable between the first position and the second position relative to the valve body 16A in response to the liquid fluid level inside the tank 12. Furthermore, the support 54A is coupled to the float 38A and movable with the float 38A between the first and second positions as discussed above for the support 54 of the valve assembly 10. Furthermore, the sealing member 60A is attached to the support 54A and has the base 62A abutting the support 54A as discussed above for the sealing member 60 and the base 62 of the valve assembly 10. The sealing member 60A also has the engagement portion 64A supported by the base 62A to define the space 66A between the engagement portion 64A and the support 54A to allow movement of the engagement portion 64A between the initial position when the float 38A is in the first position and the displaced position when the float 38A is in the second position as discussed above for the sealing member 60 of the valve assembly 10. As also discussed above for the engagement portion 64 of the valve assembly 10, the engagement portion 64A is spaced from the seat 22A when in the initial position to allow fluid communication through the outlet 28A. The engagement portion 64A engages the seat 22A when in the displaced position such that the space 66A decreases in size and the engagement portion 64A deforms about the seat 22A to cover the outlet 28A and minimize fluid communication through the outlet 28A. The float 38A and the sealing member 60A are movable as discussed above for the float 38 and the sealing member 60 of the valve assembly 10. Therefore, the different positions of the float 38A and the sealing member 60A as illustrated for the valve assembly 10 also applies to the valve assembly 10A. However, for illustrative purposes, FIGS. 8 and 10 also illustrate the different positions of the float 38A and the sealing member 60A.

As discussed above for the valve assembly 10, fluid communication between the space 66 and the cavity 24 is provided through the first and/or second holes 68, 70. As such, when the engagement portion 64 engages the first seat 22, fluid (gaseous and/or liquid fluid) is expelled out of the space 66 through the first and/or second holes 68, 70 as the space 66 decreases in size. When the engagement portion 64 disengages the first seat 22, fluid enters the space 66 through the first and/or second holes 68, 70 such that the engagement portion 64 returns to its original configuration in the initial position. Simply stated, the first and second holes 68, 70 provide bleed holes for the space 66. The first and second holes 68, 70 provide bleed holes for the space 66A for the valve assembly 10A. Furthermore, the base 62A is not sealed to the support 54A, and thus, fluid communication can occur between the base 62A and the support 54A.

The seat 22A can include the end face 30A as discussed above for the end face 30 of the valve assembly 10. The end face 30A faces the engagement portion 64A and selectively engages with the engagement portion 64A to seal the outlet 28A as discussed above for the end face 30 and the engagement portion 64 of the valve assembly 10. The end face 30A can be any suitable configuration, which includes the configuration as illustrated for the valve assembly 10, and in this embodiment, can include other configurations as well. For example, the end face 30A can be flat, tapered, sloped, arcuate, curved, concave, etc. For example, as shown in FIG. 9, the end face 30A can be curved, such that the end face 30A defines a convex configuration. By changing the configuration of the end face 30A, the way that the engagement portion 64A of the sealing member 60A engages and disengages the end face 30A can be changed as desired. As such, the way that the engagement portion 64A peels away from the end face 30A can be enhanced by changing the configuration of the end face 30A.

In addition, it is to be appreciated that the seat 22A inside the outlet 28A can include one or more protrusion(s) 144 (as best shown in FIG. 9) spaced from each other. In certain embodiments, the protrusions 144 are spaced from each other radially relative to the longitudinal axis 26. Generally, the protrusion(s) 144 extend into the outlet 28A and are disposed closer to the end face 30A than the second cavity portion 34A. For example, in certain embodiments, the protrusion(s) 144 can abut an edge of the end face 30A. The protrusion(s) 144 can be any suitable configuration. Furthermore, the protrusion(s) 144 can optionally be utilized in any of the embodiments discussed herein.

Turning to FIGS. 8 and 10, the float 38A can include the attachment member 78A extending outwardly from the first end 42A for the valve assembly 10A. In this embodiment, the ring 98 as discussed for the valve assembly 10 is removed or eliminated. Therefore, a distal end 146 of the attachment member 78A is exposed. By removing the ring 98, at high flow rates of the gaseous fluid, there is less restriction of the flow through the outlet 28A.

Also, the valve assembly 10A can include an alignment ring 148 surrounding the seat 22A. The distal end 146 of the attachment member 78A is exposed to selectively engage the alignment ring 148. The alignment ring 148 and the seat 22A each extend into the first cavity portion 32A. Specifically, the alignment ring 148 can extend from the plate 36A, and thus, the plate 36A can support the alignment ring 148. The plate 36A, the seat 22A and the alignment ring 148 can be part of the first body piece 116. The alignment ring 148 and the seat 22A are spaced from each other to define a groove 150 therebetween. In certain embodiments, the alignment ring 148 and the seat 22A are spaced from each other radially relative to the longitudinal axis 26. The distal end 146 of the attachment member 78A can be disposed in the groove 150 when the float 38A is in the second position (see FIG. 10).

Continuing with FIGS. 8 and 10, the alignment ring 148 can include an inner surface 152 facing the seat 22A. In other words, the inner surface 152 of the alignment ring 148 can face the groove 150. Furthermore, in certain embodiments, the inner surface 152 of the alignment ring 148 can face the longitudinal axis 26. As discussed above, the attachment member 78A extends to the distal end 146. The distal end 146 of the attachment member 78A can engage the inner surface 152 of the alignment ring 148 when the float 38A is in the second position (see FIG. 10). Therefore, generally, the distal end 146 of the attachment member 78A and the alignment ring 148 cooperate to guide the float 38A, and thus the sealing member 60A, relative to the seat 22A when in the second position. As such, the distal end 146 of the attachment member 78A and the alignment ring 148 cooperate to assist in aligning the engagement portion 64A of the sealing member 60A relative to the end face 30A of the seat 22A.

As best shown in FIG. 8, in certain embodiments, the inner surface 152 of the alignment ring 148 can include a first guide 154 and the distal end 146 of the attachment member 78A can include a second guide 156. The first and second guides 154, 156 cooperate to guide the distal end 146 of the attachment member 78A inside the alignment ring 148 to align the sealing member 60A relative to the seat 22A. Said differently, the first and second guides 154, 156 cooperate to guide the distal end 146 of the attachment member 78A into the groove 150 between the alignment ring 148 and the seat 22A to align the sealing member 60A relative to the seat 22A. The first and second guides 154, 156 can be any suitable configuration, and non-limiting examples can include flat, tapered, curved, etc.

Turning to FIG. 11, the support 54A can include the coupler 82A engaging the attachment member 78A to movably couple the support 82A to the float 38A as discussed above for the valve assembly 10. Therefore, see above for the detailed discussion of the features of the coupler 82 which also applies to the coupler 82A of the valve assembly 10A.

The support 54A and the sealing member 60A cooperate to define a drum seal or a flapper. As such, the flapper can be movable relative to the attachment member 78A. The sealing member 60A closes the outlet 28A quickly and crisply such that the sealing member 60A does not flutter partially engaging the seat 22A and thus partially covering the outlet 28A. By allowing movement of the flapper relative to the attachment member 78A, this movement assists in quickly and crisply sealing and unsealing. The flapper can be light weight which also assists in closing the outlet 28A quickly and crisply because the flapper can be sucked up to the outlet 28A due to the egress of vapor.

Continuing with FIG. 11, the float 38A can include a plurality of columns 90A, 92A, 158, 160 spaced from each other and each extends to a distal end 162. The number of columns 90A, 92A, 158, 160 for the valve assembly 10A is different from the valve assembly 10 (compare FIG. 3 with FIG. 11). Specifically, there can be more columns 90A, 92A, 158, 160 for the valve assembly 10A as compared to the valve assembly 10. Furthermore, as mentioned above, in this embodiment, the ring 98 is removed or eliminated; and additionally, since the ring 98 is removed, the ribs 100 as discussed above can be removed because the ribs 100 cooperated with the ring 98 to further assist in aligning the float 38. By removing the ring 98, the distal end 162 of each of the columns 90A, 92A, 158, 160 is exposed. Therefore, depending on the lengths of the columns 90A, 92A, 158, 160, the distal end 162 of each of the columns 90A, 92A, 158, 160 can be disposed in the groove 150 when the float 38A is in the second position. As such, in certain embodiments, the distal end 162 of the columns 90A, 92A, 158, 160 can engage the inner surface 152 of the alignment ring 148 when the float 38A is in the second position. Therefore, the columns 90A, 92A, 158, 160 can assist in guiding the float 38A, and thus the sealing member 60A, relative to the seat 22A when in the second position.

In certain embodiments, the plurality of columns 90A, 92A, 158, 160 can include a first column 90A and a second column 92A generally aligning with each other, and the plurality of columns 90A, 92A, 158, 160 can include a third column 158 and a fourth column 160 generally aligning with each other. As best shown in FIG. 11, the first, second, third and fourth columns 90A, 92A, 158, 160 are spaced from each other. Furthermore, the attachment member 78A is spaced from the first, second third and fourth columns 90A, 92A, 158, 160. Generally, at least part of the seat 22A is surrounded by the attachment member 78A and the first, second third and fourth columns 90A, 92A, 158, 160 when the float 38A is in the second position.

Therefore, generally, the columns 90A, 92A, 158, 160 and the attachment member 78A are spaced from each other to define a void 164 therebetween. In certain embodiments, the columns 90A, 92A, 158, 160 and the attachment member 78A are spaced radially from each other relative to the longitudinal axis 26. The end face 30A of the seat 22A is surrounded by the columns 90A, 92A, 158, 160 and the attachment member 78A when the float 38A is in the second position. Said differently, the end face 30A of the seat 22A is disposed in the void 164 when the float 38A is in the second position. Generally, the sealing member 60A is disposed in the void 164. More specifically, the engagement portion 64A of the sealing member 60A is surrounded by the columns 90A, 92A, 158, 160 and the attachment member 78A.

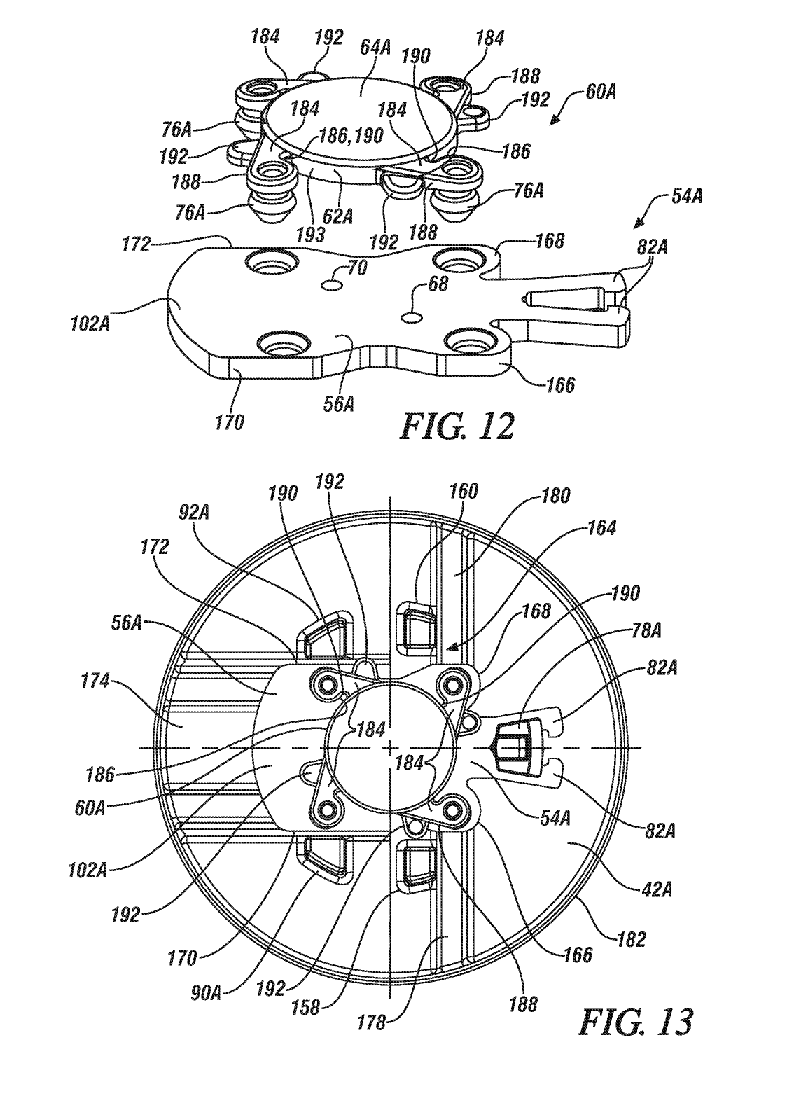

Referring to FIG. 12, the support 54A can include a first arm 166 and a second arm 168 spaced from each other and each spaced from the coupler 82A. The first and second arms 166, 168 are identified with reference numbers in the embodiment for the valve assembly 10A, and additionally these arms are illustrated in the embodiment for the valve assembly 10 but are not numbered. Also referring to FIG. 13, the first arm 166 can selectively engage the third column 158 and the second arm 168 can selectively engage the fourth column 160 to limit rotational movement of the support 54A relative to the longitudinal axis 26 to position the engagement portion 64A of the sealing member 60A relative to the seat 22A.

Furthermore, as shown in FIG. 12, the support 54A can include the tail 102A which is configured differently than the tail 102 for the valve assembly 10. The tail 102A in this embodiment is elongated as compared to the tail 102 for the valve assembly 10. The tail 102A can oppose the coupler 82A as shown in FIGS. 12 and 13. The tail 102A can assist in balancing the support 54A. In other words, the tail 102A can generally counter-balance the coupler 82A.

As best shown in FIG. 12, the tail 102A can include a first side edge 170 and a second side edge 172. The first and second side edges 170, 172 face away from each other. The first side edge 170 can selectively engage the first column 90A and the second side edge 172 can selectively engage the second column 92A to limit rotational movement of the support 54A relative to the longitudinal axis 26 to position the engagement portion 64A of the sealing member 60A relative to the seat 22A.

As similarly discussed above for the support 54 of the valve assembly 10, the support 54A of this embodiment can include the first side 56A and the second side 58A opposing the first side 56A. Generally, the second side 58A of the support 54A faces the first end 42A of the float 38A. Referring to FIGS. 11 and 13, the first end 42A of the float 38A can define a first recess 174 between the first and second columns 90A, 92A. Part of the second side 58A of the support 54A is disposed over the first recess 174 to present a first drain therebetween. Therefore, if liquid fluid, such as fuel, accumulates between the first end 42A of the float 38A and the support 54A, the fuel will drain away from the support 54A through the first drain which can assist in keeping fuel away from the sealing member 60A. As such, the first recess 174 also improves air flow under the support 54A without causes the sealing member 60A to lift at an undesirable time. Optionally, the first end 42A of the float 38A can include a tapered surface 176 (see FIG. 8) inside the first recess 174. Said differently, the first end 42A of the float 38A inside the first recess 174 can be tapered which can assist in draining the fuel away from the sealing member 60A. It is to be appreciated that the first end 42A of the float 38A inside the first recess 174 can be any suitable configuration, and non-limiting examples can include flat, tapered, curved, etc.

Continuing with FIGS. 11 and 13, the first end 42A of the float 38A can define a second recess 178 spaced from the first recess 174. The first and second recesses 174, 178 are disposed in different directions. Another part of the second side 58A is disposed over the second recess 178 to present a second drain therebetween. Therefore, if liquid fluid, such as fuel, accumulates between the first end 42A of the float 38A and the support 54A, the fuel will drain away from the support 54A through the second drain which can assist in keeping fuel away from the sealing member 60A. As such, the second recess 178 also improves air flow under the support 54A. Optionally, the first end 42A of the float 38A can include a tapered surface inside the second recess 178. Said differently, the first end 42A of the float 38A inside the second recess 178 can be tapered which can assist in draining the fuel away from the sealing member 60A. The tapered surface in the second recess 178 can be tapered as illustrated for the first recess 174. It is to be appreciated that the first end 42A of the float 38A inside the second recess 178 can be any suitable configuration, and non-limiting examples can include flat, tapered, curved, etc.

Again continuing with FIGS. 11 and 13, the first end 42A of the float 38A can define a third recess 180 disposed in a different direction from the first recess 174. The second and third recesses 178, 180 are spaced apart and align with each other in opposing directions. Yet another part of the second side 58A is disposed over the third recess 180 to present a third drain therebetween. Therefore, if liquid fluid, such as fuel, accumulates between the first end 42A of the float 38A and the support 54A, the fuel will drain away from the support 54A through the third drain which can assist in keeping fuel away from the sealing member 60A. As such, the third recess 180 also improves air flow under the support 54A. Optionally, the first end 42A of the float 38A can include a tapered surface inside the third recess 180. Said differently, the first end 42A of the float 38A inside the third recess 180 can be tapered which can assist in draining the fuel away from the sealing member 60A. The tapered surface in the third recess 180 can be tapered as illustrated for the first recess 174. It is to be appreciated that the first end 42A of the float 38A inside the third recess 180 can be any suitable configuration, and non-limiting examples can include flat, tapered, curved, etc.

The float 38A includes an outer periphery 182 facing outwardly away from the longitudinal axis 26. One or more of the first, second and third recesses 174, 178, 180 can intersect the outer periphery 182 to assist in draining the fuel away from the sealing member 60A. As best shown in FIG. 13, all of the recesses 174, 178, 180 intersect the outer periphery 182.

Turning to FIGS. 12 and 13, the sealing member 60A can include a plurality of extensions 184 spaced from each other, and each of the extensions 184 can include an inner side 186 and an outer side 188. The inner side 186 of each of the extensions 184 can define a depression 190 which can allow the engagement portion 64A of the sealing member 60A to rotate relative to the support 54A and/or prevent the engagement portion 64A of the sealing member 60A from buckling. The depression 190 can reduce stiffness of the inner side 186 of the extensions 184. The extensions 184, the inner and outer sides 186, 188 of the extensions 184 and the depression 190 of the extensions 184 are identified with reference numbers in the embodiment for the valve assembly 10A but are illustrated in the embodiment for the valve assembly 10.

Furthermore, for the valve assembly 10A, the outer side 188 of each of the extensions 184 can include a projection 192 extending outwardly therefrom to increase stiffness the outer side 188 of the extensions 184. Comparing FIGS. 3 and 13, the sealing member 60 of the valve assembly 10 does not illustrate the projections 192. As one example, the depression 190 and the projection 192 of each of the extensions 184 can cooperate to allow the engagement portion 64A of the sealing member 60A to rotate relative to the support 54A. Allowing the engagement portion 64A of the sealing member 60A to rotate relative to the support 54A can occur during a condition. As another example, the depression 190 and the projection 192 of each of the extensions 184 can prevent the engagement portion 64A of the sealing member 60A from buckling. Preventing the engagement portion 64A of the sealing member 60A from buckling can also occur during the condition. The condition can be when the sealing member 60A is exposed to fuel which can cause the sealing member 60A to swell, and therefore, the configuration of the sealing member 60A with the depressions 190 and the projections 192 can cause the engagement portion 64A to rotate and/or prevent the engagement portion 64A from buckling. For example, the engagement portion 64A can rotate in a clockwise or counter-clockwise direction relative to the longitudinal axis 26 when the sealing member 60A swells, and when the sealing member 60A returns to its original size, the engagement portion 64A can rotate in the opposite direction relative to the longitudinal axis 26 to return to its original position. It is to be appreciated that one of the coupling members 76A (same coupling members 76 as discussed above for the valve assembly 10) can extend from the respective extensions 184. As also illustrated for the valve assembly 10, the coupling members 76 are illustrated extending from respective extensions (which are not numbered in the Figures for the embodiment of the valve assembly 10). It is to be appreciated that the sealing member 60A can be attached to the support 54A by adhesive, welding, over-molding, molded plastic, elastomer attachment techniques, fasteners such as hooks, staples, dovetails, snap-locks, feet, snap feet, rubber beams with an enlarged bead at the end, etc., or any other suitable method.

As shown in FIGS. 3, 12 and 13, at least a portion of the outer side 188 of each of the extensions 184 can be a substantially flat configuration. The sealing member 60, 60A can include an outer periphery 193 (numbered in FIG. 12), and at least the portion of the outer side 188 of each of the extensions 184 can extend non-tangentially (as best shown in FIG. 13) from the outer periphery 193. In certain embodiments, the outer periphery 193 surrounds the engagement portion 64A. Optionally, the projections 192 can be eliminated (the projections 192 are eliminated in FIG. 3). As suggested, the configuration of the sealing member 60 can be utilized with the embodiment of the valve assembly 10A. Therefore, in certain embodiments, the entire outer side 188 of each of the extensions 184 can be a substantially flat configuration. The outer side 188 of each of the extensions 184 can extend non-tangentially from the outer periphery 193 to respective distal ends. In certain embodiments, the outer periphery 193 is substantially circular in configuration. The outer side 188 of each of the extensions 184 and the outer periphery 193 cooperate, and more specifically, can cooperate non-tangentially, to allow the engagement portion 64, 64A to rotate relative to the support 54, 54A and/or prevent the engagement portion 64, 64A from buckling, as discussed in the paragraph immediately above, and therefore, will not be further discussed.

The support 54A and the float 38A can include the centering mechanism 104 as discussed above for the valve assembly 10. Therefore, see above for the detailed discussion of the centering mechanism 104 which can be utilized in the valve assembly 10A. It is to be appreciated that the centering mechanism 104 can be other configurations than discussed above, for example, the cone 106 could be configured as a pin, leg(s), ramp(s), dome, etc., and the conical aperture 110 could be formed from leg(s), ramp(s), etc. The outlet 28A, the distal end 108 of the cone 106 and the distal surface 112 are coaxial with each other, and in certain embodiments coaxial relative to the longitudinal axis 26. As such, the centering mechanism 104 ensures that the outlet 28A and the engagement portion 64A will always align with each other to close off the outlet 28A regardless of any minor manufacturing variances or tolerances. The first end 42A of the float 38A can include be any suitable configuration, and non-limiting examples can include a tapered surface, a flat surface, a curved surface, etc. Therefore, the portion of the centering mechanism 104 disposed on the first end 42A of the float 38A can be disposed on a tapered surface, a flat surface, a curved surface, etc. The below discussion orientates the first, second and third recesses 174, 178, 180 relative to the centering mechanism 104.

The second side 58A of the support 54A can face the first end 42A of the float 38A. The first recess 174 can extend away from the cone 106. Therefore, the first recess 174 extends away from the cone 106 in a first direction. The first and second recesses 174, 178 can be disposed in different directions relative to the cone 106. Therefore, the second recess 178 can extend away from the cone 106 in a second direction different from the first direction. The third recess 180 can be disposed in a different direction from the first recess 174 relative to the cone 106. Therefore, the third recess 180 can extend away from the cone 106 in a third direction different from the first direction. The second and third recesses 178, 180 are spaced apart and align with each other in opposing directions. Therefore, the second and third directions oppose each other.

The valve assembly 10A can also include a cover 194 (see FIGS. 7 and 8). The cover 194 can close a top of the second cavity portion 34A. One or more beams 196 can extend into the second cavity portion 34A to support a center portion of the cover 194. Optionally, before sealing the cover 194 to the first body piece 116, the cover 194 also easily allows for the addition of a ball 198 (shown in FIG. 7 for illustrative purposes only), a disc, a cylinder or any other suitable configuration component, inside the second cavity portion 34A to act as a head valve.

The adaptor piece 118 can surround the cover 194 and the cover 194 can be disposed inside the central opening 122, i.e., recessed below the top of the adaptor piece 118, which provides a more compact valve design as compared to the valve assembly 10 of FIG. 4. Therefore, the adaptor piece 118 can surround the cover 194 as well as the optional head valve.

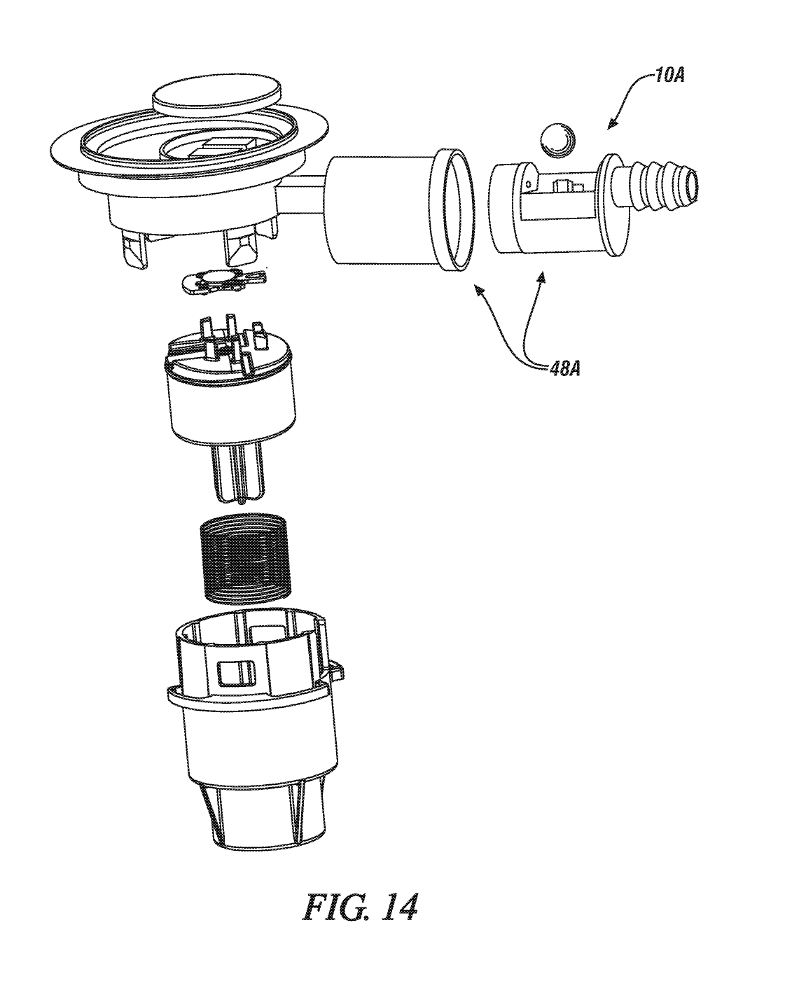

The valve assembly 10A can also include various other components and be other various configurations. For example, as shown in FIG. 14, the valve assembly 10A can optionally include a head valve 48A extending from a side of the valve body 16A. The head valve 48A operates as described above for the head valve 48. The head valve 48A in FIG. 14 can be referred to as a side car. Instead of utilizing a side car head valve 48A, as discussed above for FIG. 14, FIG. 7 illustrates the optional location of a head valve beneath the cover 194.

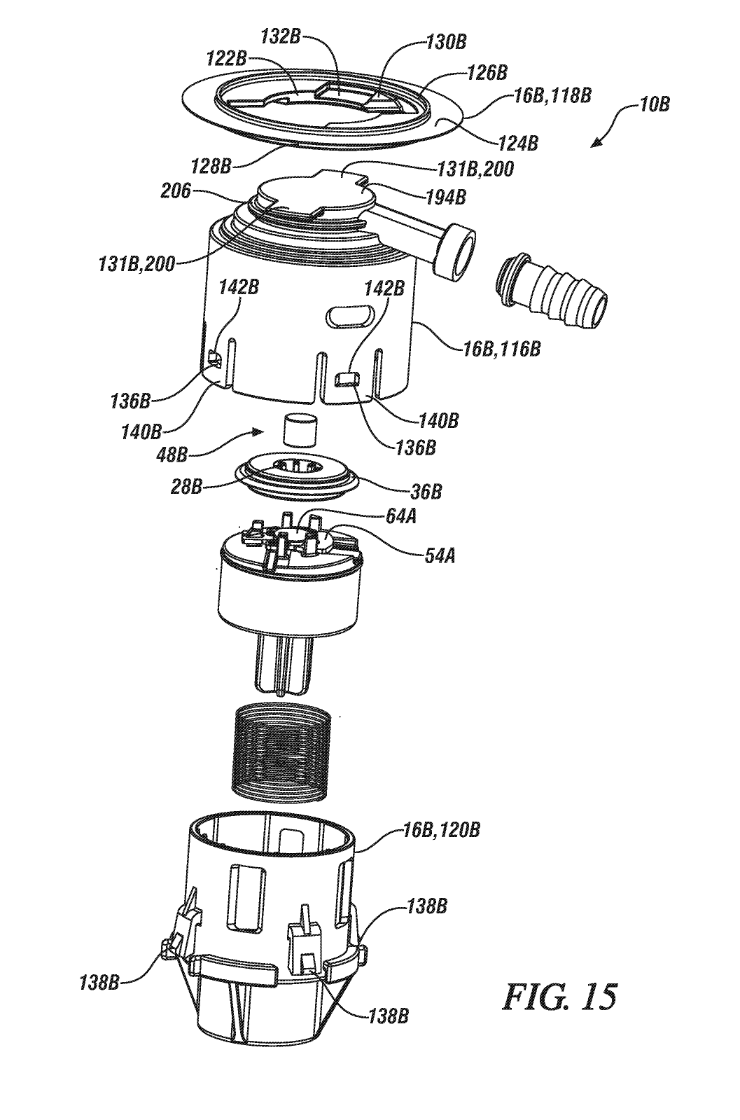

Another valve assembly 10B is illustrated in FIGS. 15-18, which is a modification of the valve assembly 10A. In this embodiment, the first body piece 116 of the valve assembly 10A, the adaptor piece 118 of the valve assembly 10A and the second body piece 120 of the valve assembly 10A are modified. The configuration of the float 38A of the valve assembly 10A can be utilized in the valve assembly 10B, and therefore, the features of the float 38A will not be re-discussed. Additionally, the configuration of the support 54, 54A of the valve assembly 10, 10A and the configuration of the sealing member 60, 60A of the valve assembly 10, 10A, i.e., the drum seal or the flapper, can be utilized in the valve assembly 10B, and therefore, the features of the drum seal/flapper will not be re-discussed. The configuration of the alignment ring 148 of the valve assembly 10A and the seat 22A of the valve assembly 10A can be utilized in the valve assembly 10B, and therefore, the features of the alignment ring 148 and the seat 22A will not be re-discussed. The main differences between the valve assemblies 10A, 10B are discussed below.

The valve assembly 10B can be formed of a plurality of pieces 116B, 118B, 120B attached to each other separately. Specifically, the valve body 16B can include a first body piece 116B and an adaptor piece 118B being a separate piece from the first body piece 116B. Furthermore, the valve body 16B can include a second body piece 120B being a separate piece from the first body piece 116B. The first body piece 116B is attachable to the adaptor piece 118B by a snap fit operation. Additionally, the first body piece 116B and the second body piece 120B are attachable to each other by another snap fit operation. By having the adaptor piece 118B being a separate piece from the first body piece 116B and attached to each other in the snap fit operation, an overmolding process can be eliminated as compared to a design where the valve body is one piece. Eliminating the overmolding process to make a one piece body can reduce costs.

The adaptor piece 118B can define a central opening 122B and can include a first flange 124B extending outwardly away from the central opening 122B. The adaptor piece 118B can include an inner surface 126B facing the central opening 122B and an outer surface 128B opposing the inner surface 126B. The first flange 124B can extend from the outer surface 128B away from the central opening 122B. The outer surface 128B of the adaptor piece 118B and/or the first flange 124B can be attached to the tank 12 to secure the valve assembly 10B relative to the tank 12.

Referring to FIGS. 15, 17 and 18, the inner surface 126B of the adaptor piece 118B can include one or more first attachment features 130B, 132B. In this embodiment, the configuration of the first attachment features 130B, 132B are different from the configuration of the first attachment features 130B, 132B of FIG. 7. The first attachment features 130B, 132B can include one or more ramps 130B and one or more recessed platforms 132B. One ramp 130B is disposed juxtaposed to one recessed platform 132B, and so on depending on the number of ramps 130B and the number of recessed platforms 132B. The first attachment features 130B, 132B will be discussed further below.

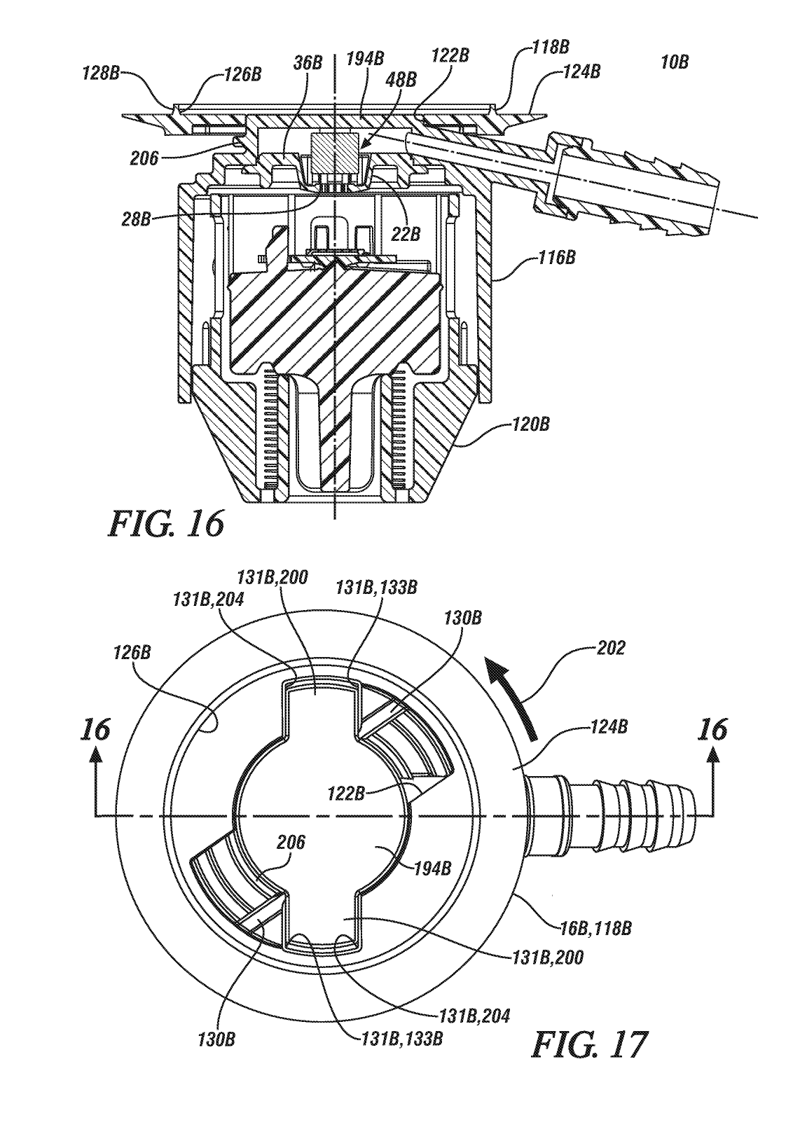

As best shown in FIGS. 15 and 16, the cover 194B and the first body piece 116B can be formed as one piece (instead of separate pieces as shown in FIG. 7). Therefore, the first body piece 116B can include the cover 194B. The cover 194B can include one or more strips 200 extending outwardly therefrom, and the central opening 122B is complementary to the cover 194B and the strips 200. In certain embodiments, the strips 200 can be spaced from each other. For example, as shown in FIG. 15, the strips 200 can oppose each other in a spaced relationship. Additionally, the first body piece 116B can optionally include a lip 206 spaced from the strips 200.

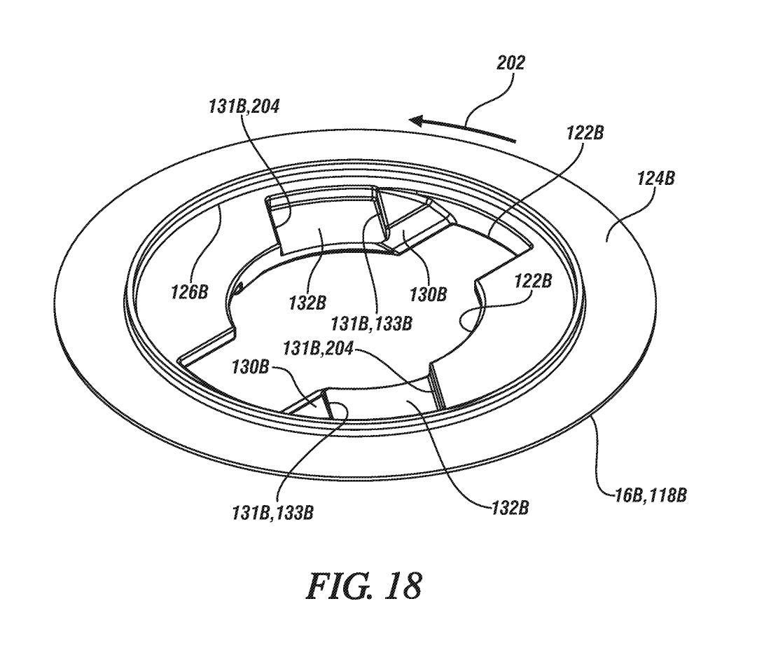

Therefore, when snap fitting the first body piece 116B and the adaptor piece 118B together, the cover 194B and the strips 200 are inserted through the central opening 122B and one or both of the pieces 116B, 118B are rotated relative to each other such that the strips 200 ride up the respective ramps 130B and into the respective recessed platforms 132B on the other side of the respective ramps 130B, thus attaching the pieces 116B, 118B together. In certain embodiments, a portion of the adaptor piece 120B is trapped between the strips 200 and the lip 206 when the pieces 116B, 118B are attached to each other, which prevents the strips 200 from lifting out of the respective recessed platforms 132B. FIG. 18 illustrates the direction (see arrow 202) that the strips 200 will rotate relative to the ramps 130B. It is to be appreciated that the ramps 130B and the recessed platforms 132B can be on the other side of the central opening 122B such that the strips 200 rotate in the opposite direction from arrow 202. FIG. 17 illustrates the strips 200 disposed in respective recessed platforms 132B.

Additionally, the adaptor piece 118B and the first body piece 116B can each include an anti-rotation apparatus 131B that prevents rotation of the adaptor piece 118B and the first body piece 116B relative to each other. Specifically, each of the ramps 130B can include a first step 133B which extends above the respective recessed platform 132B. Therefore, once the respective strips 200 passes the respective ramps 130B, the strips 200 drop into the respective recessed platforms 132B, and the first step 133B prevents the strips 200 from rotating back toward the respective ramps 130B, i.e., prevents rotation in the opposite direction of arrow 202. Additionally, the adaptor piece 118B can include one or more second steps 204 spaced from the first step 133B, which prevents rotation of the strips 200 in the direction of arrow 202. Therefore, once the respective strips 200 passes the respective ramps 130B, the strips 200 drop into the respective recessed platforms 132B, and the second step 204 prevents the strips 200 from rotating in the direction of arrow 202. Therefore, the first and second steps 133B, 204 cooperate such that when the respective strips 200 engage the respective step 133B, 204, rotation is prevented. The anti-rotation apparatus 131B can include at least the first and second steps 133B, 204 and the strips 200, and corresponding features discussed above.

As discussed above, the first body piece 116B and the second body piece 120B are attachable to each other. The first and second body pieces 116B, 120B can each include one or more second attachment features 136B, 138B (see FIG. 15) to secure the first and second body pieces 116B, 120B together. For example, the second attachment features 136B, 138B can include one or more second shoulders 136B and one or more second tabs 138B, with respective second tab(s) 138B cooperating with respective second shoulder(s) 136B to attach the first and second body pieces 116B, 120B together by engaging each other. For example, the second tabs 138B can bias as the second tabs 138B slide over respective second shoulders 136B to snap in place and secure the first and second body pieces 116B, 120B together. In certain embodiments, the second tab(s) 138B can extend from the second body piece 120B and the second shoulder(s) 136B can extend from the first body piece 116B. Alternatively, in other embodiments, the second tab(s) 138B can extend from the first body piece 116B and the second shoulder(s) 136B can extend from the second body piece 120B. In yet other embodiments, one or more second shoulder(s) 136B and one or more second tab(s) 138B can extend from both of the first and second body pieces 116B, 120B in an arrangement that the respective tab(s) 138B and the respective shoulder(s) 136B cooperate to secure the first and second body pieces 116B, 120B together.

Continuing with FIG. 15, the first body piece 116B can include one or more attachment support(s) 140B, with one of the second shoulder(s) 136B supported by each of the attachment support(s) 140B Furthermore, the attachment support(s) 140B can be biasable. Each of the attachment support(s) 140B can define a slot 142B, with the respective second shoulder(s) 136B disposed adjacent to the respective slot 142B. As such, when attaching the first and second body pieces 116B, 120B together, the respective attachment support 140B and/or the second tabs 138B can bias relative to each other until a portion of the second tab 138B rests in the respective slot 142B such that the portion of the second tab 138B engages the respective second shoulder(s) 136B.

The adaptor piece 118B can surround the cover 194B and the cover 194B can be recessed below the top of the adaptor piece 118B, which provides a more compact valve design as compared to the valve assembly 10 of FIG. 4. Therefore, the adaptor piece 118B can surround the cover 194B as well as the optional head valve.

The valve assembly 10B can also include various other components and be other various configurations. For example, as shown in FIG. 15, the valve assembly 10B can optionally include a head valve 48B. The head valve 48B operates as described above for the head valve 48 and can optionally be beneath the cover 194B. Furthermore, the plate 36B can be a separate component attached to the first body piece 116B (instead of being one piece with the first body piece 116A as shown in FIG. 8). The seat 22B and the outlet 28B are part of the plate 36B. The seat 22B is a separate component from the valve body 16B and is attachable to the valve body 16B. The seat 22B, and thus the plate 36B, can be attached to the valve body 16B by any suitable methods, and non-limiting examples can include welding, adhesive, fasteners, etc. By having the plate 36B as a separate component, the valve assembly 10B can be customized to the desired size and/or shape of the outlet 28B, which will be discussed further below.

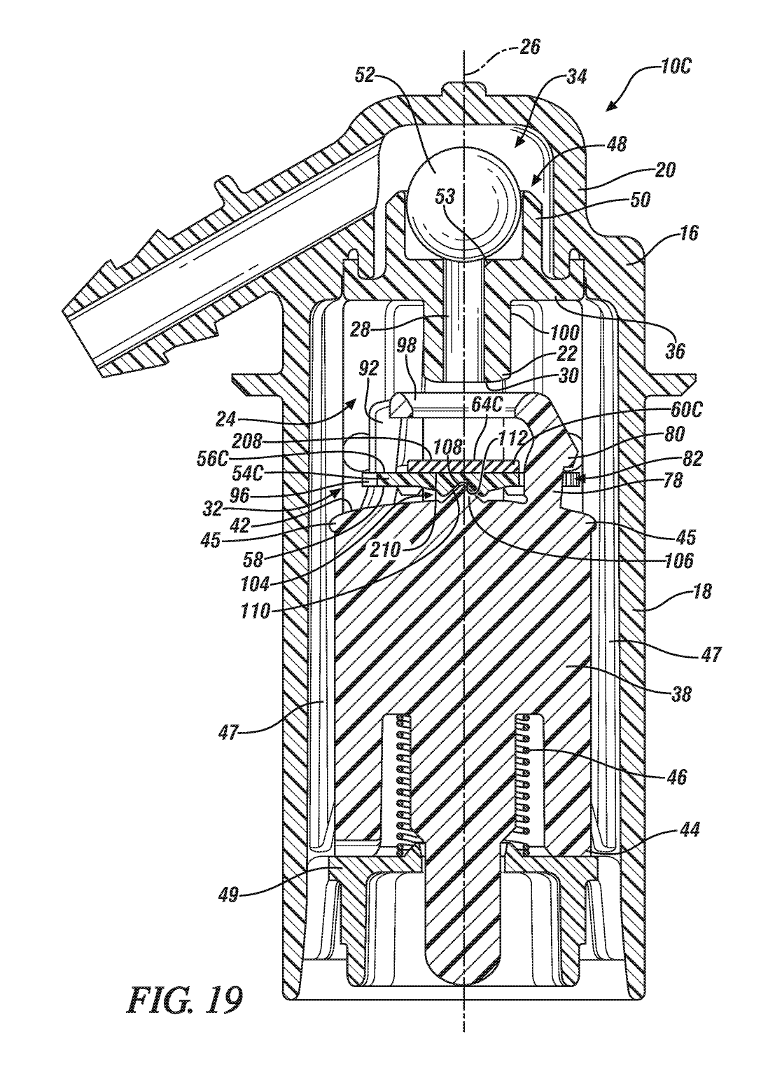

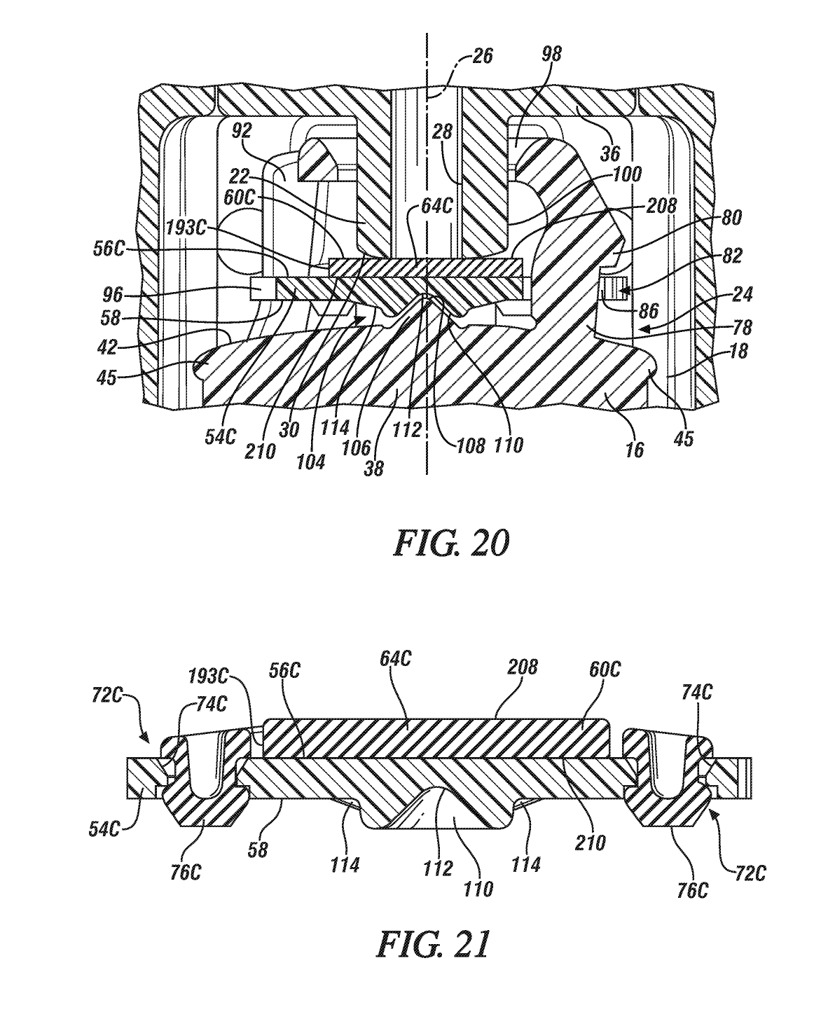

Optionally, various internal components of the valve assemblies 10, 10A, 10B discussed herein can be utilized with a drum seal 54C, 60C of another configuration. As such, another embodiment of a valve assembly 10C is described below with regard to FIGS. 19-21. Similar or the same components will have the same reference numbers. The basic operation of the valve assembly 10C is the same as discussed above for the valve assemblies 10, 10A, 10B. The below discussion focuses on the differences of the drum seal 54, 54A, 60, 60A.

Referring to FIGS. 19-21, the sealing member 60C and the support 54C are configured differently than the sealing members 60, 60A and the supports 54, 54A of the other embodiments. Specifically, the space 66, 66A of the sealing members 60, 60A has been eliminated, and the first and second holes 68, 70 of the supports 54, 54A have been eliminated. The configuration of the sealing member 60C discussed below provides an additional variation of the compliancy and/or stiffness of the engagement portion 64C as desired for the valve assembly 10, 10A, 10B.

Again for the embodiment of FIGS. 19-21, the sealing member 60C is attached to the support 54C. The support 54C can be configured the same as the other embodiments discussed herein. The sealing member 60C can be secured to the support 54C as discussed above for the support 54. Specifically, the support 54C can define a mounting portion 72C to attach the sealing member 60C to the support 54A. In certain embodiments, the mounting portion 72C is further defined as plurality of mounting portions 72C cooperating with the sealing member 60C to secure the sealing member 60C to the support 54C. The mounting portions 72C can be spaced from each other and can be any suitable configuration. For example, each of the mounting portions 72C can define an aperture 74C. The sealing member 60C can include coupling members 76C, such as feet, spaced from each other, with each of the coupling members 76C disposed in respective apertures 74C. The coupling members 76C can be deformed to be inserted through the respective apertures 74C.

The sealing member 60C has an engagement portion 64C spaced from the seat 22 when the float 38 is in the first position and engaging the seat 22 when the float 38 is in the second position. The engagement portion 64C includes a first surface 208 and a second surface 210 opposing the first surface 208. The first surface 208 faces the seat 22 and the second surface 210 abuts the support 54C. More specifically, the second surface 210 of the engagement portion 64C engages the first side 56C of the support 54C. In certain embodiments, the entire second surface 210 can abut the first side 56C of the support 54C.

The engagement portion 64C completely extends from the first surface 208 to the second surface 210. In other words, the engagement portion 64C is characterized by the absence of the space 66, 66A. The sealing member 60C can include an outer periphery 193C that surrounds the engagement portion 64C. Therefore, in certain embodiments, the engagement portion 64C completely extends from the first surface 208 to the second surface 210 and completely extends to the outer periphery 193C.

At least a segment of the sealing member 60C can be formed of a material, which can include a flexible material, a plastic material or combinations thereof. In certain embodiments, the entire sealing member 60C is formed of the flexible material or the plastic material. In other embodiments, the segment of the sealing member 60C can be the engagement portion 64C. Therefore, the engagement portion 64C can be formed of a flexible material, a plastic material or combinations thereof. In certain embodiments, the engagement portion 64C can be formed of an elastomer. One suitable elastomer is a fluorinated elastomer. In certain embodiments, the elastomer is fluorosilicone. It is to be appreciated that any other suitable flexible material, plastic material or combinations thereof, can be utilized.

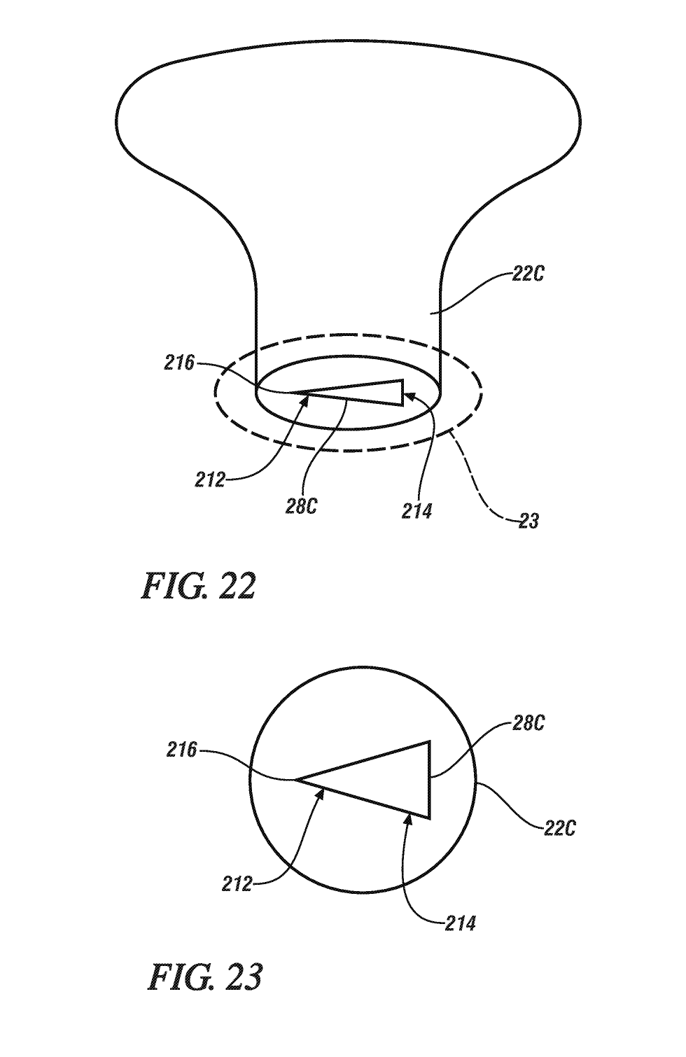

Referring to FIGS. 22 and 23, optionally, the configuration of the outlet 28C defined by the seat 22C can be changed. It is to be appreciated that the outlet 28, 28A, 28B, 28C can be changed for any of the embodiments discussed herein, and therefore, this discussion applies to all of the embodiments herein. By changing the configuration of the outlet 28, 28A, 28B, 28C, the valve assembly 10, 10A, 10B, 10C can be customized to the desired flow rate and/or sealing characteristics. Furthermore, as discussed above, any of the embodiments can include one or more of the protrusion(s) 144 as best shown in FIG. 9. For example, as shown in these Figures, the outlet 28C can be configured as a triangle. In certain embodiments, the triangle is an isosceles triangle. The configuration of the outlet 28C can be different than illustrated in FIGS. 22 and 23. For example, the outlet 28C can be a circular configuration, a square configuration, a polygon configuration, an oval configuration, a tear-drop configuration, or any other suitable configuration or combination of configurations.

Optionally, the outlet 28C defines a narrow region 212 and a wide region 214, with the wide region 214 having an area greater than the narrow region 212. The support 54, 54A is orientated relative to the narrow and wide regions 212, 214 in a particular manner to reduce the amount of force needed by the float 38, 38A to open the outlet 28C. Generally, the coupler 82, 82A is disposed closer to the narrow region 212 than the wide region 214. Furthermore, the tail 102, 102A is disposed closer to the wide region 214 than the narrow region 212. As one non-limiting example, taking the orientation of the support 54A in FIG. 13, a most distal end 216 (numbered in FIGS. 22 and 23) of the narrow region 212 can align on the axis that intersects the attachment member 78A and extends between the couplers 82A. Therefore, the engagement portion 64, 64A peels off the seat 22, 22A starting at the narrow region 212 and then the wide region 214 which reduces the amount of force needed by the float 38, 38A to open the outlet 28C. It is to be appreciated that other orientations of the outlet 28C relative to the support 54, 54A can be utilized.

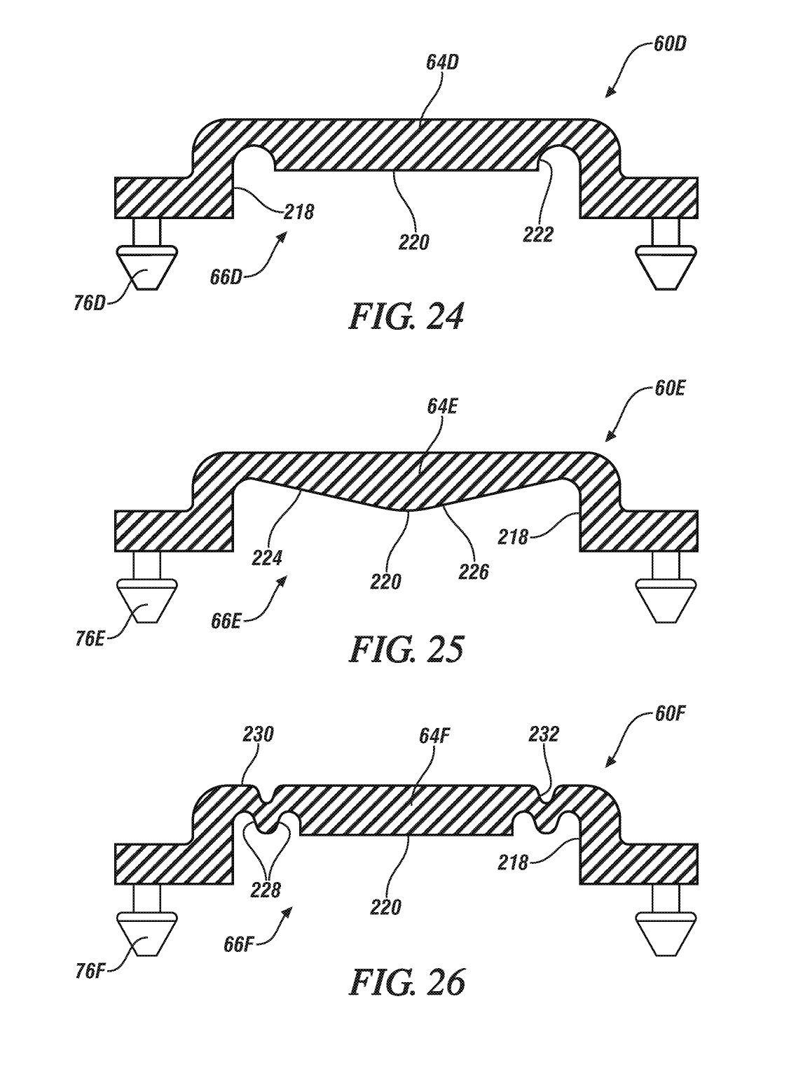

Referring to FIGS. 24-26, the sealing member 60D, 60E, 60F can have other configurations than discussed above, and these sealing members 60D, 60E, 60F can be utilized in any of the embodiments of FIGS. 1-18. Generally, for these embodiments, the sealing member 60D, 60E, 60F can include coupling members 76D, 76E, 76F, such as feet, spaced from each other, as similarly discussed above for the coupling members 76. Additionally, for these embodiments, the sealing member 60D, 60E, 60F defines the space 66D, 66E, 66F. However, the space 66D, 66E, 66F is configured differently than the other embodiments. Furthermore, in these embodiments, the support 60, 60A as discussed for embodiments of FIGS. 1-18 can be utilized with the sealing member 60D, 60E, 60F. Therefore, the support 60, 60A will be not discussed further.

Turning to FIGS. 24-26, the space 66D, 66E, 66F of each of the embodiments is defined by a side wall 218 of the sealing member 60D, 60E, 60F and a back wall 220 of the sealing member 60D, 60E, 60F, with the back wall 220 facing the first side 56, 56A of the support 54, 54A. The configurations of the sealing member 60D, 60E, 60F discussed below provide additional variations of the compliancy and/or stiffness of the engagement portion 64D, 64E, 64F as desired for the valve assembly 10, 10A, 10B.

Referring to FIG. 24, the back wall 220 of the space 66D defines a groove 222 proximal to the side wall 218. In certain embodiments, the groove 222 can adjoin the side wall 218. Therefore, part of the engagement portion 64D can be thicker than the part of the engagement portion 64D that overlaps the groove 222. The groove 222 can be any suitable configuration and location relative to the back wall 220.

Referring to FIG. 25, the back wall 220 of the space 66E has an angular surface 224. The angular surface 224 can meet at a center region 226 of the back wall 220. For example, the angular surface 224 can gradually taper outwardly toward the center region 226. Therefore, the engagement portion 64E at the center region 226 is thicker than the engagement portion 64E that overlaps the angular surface 224. The angular surface 224 can be any suitable configuration and location relative to the back wall 220.

Referring to FIG. 26, the back wall 220 of the space 66F defines a plurality of first recesses 228. In certain embodiments, at least one of the first recesses 228 is disposed proximal to the side wall 218. Furthermore, in certain embodiments, at least one of the first recesses 228 can adjoin the side wall 218. Therefore, part of the engagement portion 64F can be thicker than the part of the engagement portion 64F that overlaps the first recesses 228. The first recesses 228 can be any suitable configuration and location relative to the back wall 220.

Continuing with the embodiment of FIG. 26, the engagement portion 64F includes a top surface 230 that opposes at least part of the back wall 220. The top surface 230 generally faces the seat 22, 22A, 22B. The top surface 230 can define a second recess 232. Therefore, the first recesses 228 and the second recess 232 are spaced from each other relative to the top surface 230 and the back wall 220. In certain embodiments, the second recess 232 is located between a pair of the first recesses 228 relative to the relationship between the top surface 230 and the back wall 220.

While the best modes for carrying out the many aspects of the present teachings have been described in detail, those familiar with the art to which these teachings relate will recognize various alternative aspects for practicing the present teachings that are within the scope of the appended claims.

1. A valve assembly comprising:
a valve body;
a seat defining an outlet;
a float disposed inside the valve body and movable between a first position and a second position relative to the valve body;
a support coupled to the float and movable with the float between the first and second positions;
a sealing member attached to the support and having an engagement portion spaced from the seat when the float is in the first position and engaging the seat when the float is in the second position;
wherein the engagement portion includes a first surface and a second surface opposing the first surface, with the first surface facing the seat and the second surface abutting the support; and
wherein the engagement portion completely extends from the first surface to the second surface.

2. An assembly as set forth in claim 1 wherein the float includes an attachment member extending outwardly from the first end, and wherein the support includes a coupler engaging the attachment member to movably couple the support to the float.

3. An assembly as set forth in claim 2 wherein:
the float includes a first column, a second column, a third column and a fourth column spaced from each other and each extending to a distal end, with the distal end of each of the columns and a distal end of the attachment member exposed;
the first column and the second column generally align with each other;
the third column and the fourth column generally align with each other; and
the attachment member is spaced from the first, second third and fourth columns.

4. An assembly as set forth in claim 3 wherein the support includes a first arm and a second arm spaced from each other and each spaced from the coupler, with the first arm selectively engaging the third column and the second arm selectively engaging the fourth column to limit rotational movement of the support relative to a longitudinal axis to position the engagement portion of the sealing member relative to the seat.

5. An assembly as set forth in claim 3 wherein:
the support includes a tail opposing the coupler, with the tail including a first side edge and a second side edge, with the first and second side edges facing away from each other; and
the first side edge selectively engaging the first column and the second side edge selectively engaging the second column to limit rotational movement of the support relative to a longitudinal axis to position the engagement portion of the sealing member relative to the seat.

6. An assembly as set forth in claim 3 wherein:
the support includes a first side and a second side opposing the first side, with the second side facing a first end of the float, and the second surface of the engagement portion engages the first side; and
the first end of the float defines a first recess between the first and second columns, and wherein part of the second side is disposed over the first recess to present a first drain therebetween.

7. An assembly as set forth in claim 6 wherein the first end of the float includes a tapered surface inside the first recess.

8. An assembly as set forth in claim 6 wherein the first end of the float defines a second recess spaced from the first recess, with the first and second recesses disposed in different directions, and wherein another part of the second side is disposed over the second recess to present a second drain therebetween.

9. An assembly as set forth in claim 8 wherein the first end of the float defines a third recess disposed in a different direction from the first recess, with the second and third recesses spaced apart and aligning with each other in opposing directions, and wherein yet another part of the second side is disposed over the third recess to present a third drain therebetween.

10. An assembly as set forth in claim 1 further including an alignment ring surrounding the seat and including an inner surface facing the seat, wherein the float includes an attachment member extending to a distal end, and wherein the distal end of the attachment member engages the inner surface of the alignment ring when the float is in the second position.

11. An assembly as set forth in claim 10 wherein the inner surface of the alignment ring includes a first guide and the distal end of the attachment member includes a second guide, and wherein the first and second guides cooperate to guide the distal end of the attachment member inside the alignment ring to align the sealing member relative to the seat.

12. An assembly as set forth in claim 1 wherein the sealing member includes a plurality of extensions spaced from each other and each of the extensions including an inner side and an outer side, with the inner side of each of the extensions defining a depression to allow the engagement portion of the sealing member to rotate relative to the support.

13. An assembly as set forth in claim 1 wherein the sealing member includes a plurality of extensions spaced from each other and each of the extensions including an inner side and an outer side, with the inner side of each of the extensions defining a depression to prevent the engagement portion of the sealing member from buckling.

14. An assembly as set forth in claim 1 wherein the valve body includes a first body piece and an adaptor piece being a separate piece from the first body piece, with the first body piece being attachable to the adaptor piece by a snap fit operation.

15. An assembly as set forth in claim 14 wherein the adaptor piece and the first body piece each include an anti-rotation apparatus that prevents rotation of the adaptor piece and the first body piece relative to each other.

16. A valve assembly comprising:
a valve body;
a seat defining an outlet;
wherein the seat is a separate component from the valve body and is attachable to the valve body;
a float disposed inside the valve body and movable between a first position and a second position relative to the valve body;
a support coupled to the float and movable with the float between the first and second positions;
a sealing member attached to the support, with the sealing member having an engagement portion spaced from the seat when the float is in the first position and engaging the seat when the float is in the second position; and
wherein the sealing member includes a plurality of extensions spaced from each other and an outer periphery, and each of the extensions includes an inner side and an outer side, and wherein at least a portion of the outer side of each of the extensions extends non-tangentially from the outer periphery.

17. An assembly as set forth in claim 16 wherein:
the float and the support include a centering mechanism that is configured to position the engagement portion of the sealing member relative to the seat;
the centering mechanism includes a cone extending to a distal end coaxial with a longitudinal axis; and
the float includes the cone and the centering mechanism defines a conical aperture extending into the support to a distal surface coaxial with the longitudinal axis, with the cone disposed in the conical aperture to center the sealing member relative to the longitudinal axis to position the engagement portion relative to the seat.

18. An assembly as set forth in claim 17 wherein the support includes a first side and a second side opposing the first side, with the second side facing a first end of the float, wherein the first end of the float defines a first recess extending away from the cone, and wherein part of the second side is disposed over the recess to present a first drain therebetween.

19. An assembly as set forth in claim 18 wherein the first end of the float defines a second recess spaced from the first recess, with the first and second recesses disposed in different directions relative to the cone, and wherein another part of the second side is disposed over the second recess to present a second drain therebetween.

20. An assembly as set forth in claim 18 wherein the first end of the float defines a third recess disposed in a different direction from the first recess relative to the cone, with the second and third recesses spaced apart and aligning with each other in opposing directions, and wherein yet another part of the second side is disposed over the third recess to present a third drain therebetween.
